(19) United States
(12) Patent Application Publication
(10) Pub. No.: US 2025/0371388 A1
(43) Pub. Date: Dec. 4, 2025

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: PANASONIC INTELLECTUAL PROPERTY MANAGEMENT CO., LTD., Osaka (JP)

(72) Inventors: Shota ONISHI, Osaka (JP); Yasunori Ishll, Osaka (JP); Akihiro Noda, Osaka (JP); Kazuki Kozuka, Osaka (JP)

(21) Appl. No.: 19/298,424

(22) Filed: Aug. 13, 2025

Related U.S. Application Data
(63) Continuation of application No. PCT/JP2023/044602, filed on Dec. 13, 2023.

(30) Foreign Application Priority Data
Feb. 17, 2023 (JP) 2023-023702

(51) Int. Cl. G06N 5/04

(52) U.S. Cl. CPC G06N 5/04

(57) ABSTRACT

A model presentation device includes a keyword acquisition part that acquires at least one piece of inference target data, an identification part that identifies at least one inference model according to the at least one piece of inference target data from among a plurality of inference models that output an inference result using the inference target data as an input, a presentation screen creation part that creates a presentation screen for presenting the identified at least one inference model to a user, and a display part that outputs the created presentation screen.

### FIELD OF INVENTION

The present disclosure relates to a technique of identifying an inference model optimal for inference target data from among a plurality of inference models.

### BACKGROUND ART

In recent years, with the promotion of digital transformation and the like, there is an increasing demand for a system capable of acquiring a high-performance artificial intelligence (AI) model at low cost and in a short time even by a person who is not familiar with AI.

For example, Patent Literature 1 discloses an image processing method including the steps of: receiving at least one image; dividing the received image into a plurality of image segments; executing one or more pre-stored algorithms from a plurality of image processing algorithms for each of the image segments to obtain a plurality of image processing algorithm outputs; comparing each of the image processing algorithm outputs with a predetermined threshold image processing output score; recording the image processing algorithm, together with the corresponding one or more image segments and associated feature vectors, as a training pair for each of the image processing algorithms above the predetermined threshold image processing output score; and selecting one or more potentially matching image processing algorithms from the training pair for a sent pre-processed test image.

However, in the above-described conventional technique, one or more inference models (image processing algorithms) are automatically selected, but a user cannot select an inference model suitable for a use scene unless the user is familiar with AI, and further improvement has been required.
Patent Literature 1: JP 2014-229317 A

### SUMMARY OF THE INVENTION

The present disclosure has been made to solve the above problem, and an object of the present disclosure is to provide a technique capable of presenting a user with a candidate of an inference model suitable for a use scene, and capable of reducing the cost and time required from selection to introduction of an inference model for inferring inference target data.

An information processing method according to one aspect of the present disclosure is an information processing method by a computer, the method including: acquiring at least one piece of inference target data; identifying at least one inference model according to the at least one piece of inference target data from among a plurality of inference models that output an inference result using the inference target data as an input; creating a presentation screen for presenting the identified at least one inference model to a user; and outputting the created presentation screen.

An information processing method according to another aspect of the present disclosure is an information processing method by a computer, the method including: obtaining at least one keyword; identifying at least one inference model corresponding to the at least one keyword from among a plurality of inference models that output an inference result using inference target data as an input; creating a presentation screen for presenting the identified at least one inference model to a user; and outputting the created presentation screen.

According to the present disclosure, it is possible to present a candidate of an inference model suitable for a use scene to a user, and it is possible to reduce a cost and time required from selection to introduction of an inference model for inferring inference target data.

### BRIEF DESCRIPTION OF THE DRAWINGS

FIG. 1 is a diagram illustrating a configuration of a model presentation device according to a first embodiment of the present disclosure.

FIG. 2 is a flowchart for explaining machine learning processing in the model presentation device according to the first embodiment of the present disclosure.

FIG. 3 is a flowchart for explaining model presentation processing in the model presentation device according to the first embodiment of the present disclosure.

FIG. 4 is a schematic diagram for explaining extraction of a first representative feature vector and a plurality of second representative feature vectors in the first embodiment.

FIG. 5 is a diagram illustrating an example of a presentation screen displayed on a display part in the present first embodiment.

FIG. 6 is a diagram illustrating an example of a presentation screen displayed on a display part in a first modification of the first embodiment.

FIG. 7 is a diagram illustrating an example of a presentation screen displayed on a display part in a second modification of the first embodiment.

FIG. 8 is a diagram illustrating an example of a presentation screen displayed on a display part in a third modification of the first embodiment.

FIG. 9 is a diagram illustrating an example of a first presentation screen to a third presentation screen displayed on a display part in a fourth modification of the first embodiment.

FIG. 10 is a diagram illustrating a configuration of a model presentation device according to a second embodiment of the present disclosure.

FIG. 11 is a flowchart for explaining machine learning processing in the model presentation device according to the second embodiment of the present disclosure.

FIG. 12 is a flowchart for explaining model presentation processing in the model presentation device according to the second embodiment of the present disclosure.

FIG. 13 is a diagram illustrating a configuration of a model presentation device according to a third embodiment of the present disclosure.

FIG. 14 is a schematic diagram for explaining a matching degree calculation model in the present third embodiment.

FIG. 15 is a flowchart for explaining machine learning processing in the model presentation device according to the third embodiment of the present disclosure.

FIG. 16 is a flowchart for explaining model presentation processing in the model presentation device according to the third embodiment of the present disclosure.

FIG. 17 is a diagram illustrating an example of a presentation screen displayed on a display part in the present third embodiment.

FIG. 18 is a diagram illustrating a configuration of a model presentation device according to a fourth embodiment of the present disclosure.

FIG. 19 is a flowchart for explaining model presentation processing in the model presentation device according to the fourth embodiment of the present disclosure.

FIG. 20 is a diagram illustrating a configuration of a model presentation device according to a fifth embodiment of the present disclosure.

FIG. 21 is a flowchart for explaining model presentation processing in the model presentation device according to the fifth embodiment of the present disclosure.

FIG. 22 is a diagram illustrating a configuration of a model presentation device according to a sixth embodiment of the present disclosure.

FIG. 23 is a flowchart for explaining machine learning processing in the model presentation device according to the sixth embodiment of the present disclosure.

FIG. 24 is a flowchart for explaining model presentation processing in the model presentation device according to the sixth embodiment of the present disclosure.

### DETAILED DESCRIPTION

### (Knowledge Underlying Present Disclosure)

In the above-described conventional technique, one or more inference models (image processing algorithms) matching the test image are automatically selected. However, in the conventional technique, since it is not presented that one or more inference models are an inference model suitable for what use scene, it is difficult for a user who is not familiar with AI to understand and select a feature of the inference model.

In order to solve the above problem, a technique below is disclosed.

(1) An information processing method according to one aspect of the present disclosure is an information processing method by a computer, the method including: acquiring at least one piece of inference target data; identifying at least one inference model according to the at least one piece of inference target data from among a plurality of inference models that output an inference result using the inference target data as an input; creating a presentation screen for presenting the identified at least one inference model to a user; and outputting the created presentation screen.

According to this configuration, at least one piece of inference target data is acquired, at least one inference model corresponding to the acquired at least one piece of inference target data is identified from among a plurality of inference models that output an inference result using the inference target data as an input, and the identified at least one inference model is presented to the user.

Therefore, it is possible to present a candidate of an inference model suitable for the use scene to the user based on the acquired at least one piece of inference target data, and it is possible to reduce the cost and time required from selection to introduction of an inference model for inferring the inference target data.

(2) An information processing method according to another aspect of the present disclosure is an information processing method by a computer, the method including: obtaining at least one keyword; identifying at least one inference model corresponding to the at least one keyword from among a plurality of inference models that output an inference result using inference target data as an input; creating a presentation screen for presenting the identified at least one inference model to a user; and outputting the created presentation screen.

According to this configuration, at least one keyword is acquired, at least one inference model corresponding to the acquired at least one keyword is identified from among a plurality of inference models that output an inference result using the inference target data as an input, and the identified at least one inference model is presented to the user.

Therefore, it is possible to present a candidate of an inference model suitable for the use scene to the user based on the acquired at least one keyword, and it is possible to reduce the cost and time required from selection to introduction of an inference model for inferring the inference target data.

(3) In the information processing method according to (1), in the identifying of the at least one inference model, a first representative feature vector of the acquired at least one piece of inference target data may be extracted, a distance between the extracted first representative feature vector and a second representative feature vector of each of a plurality of training data sets used for machine learning of each of the plurality of inference models may be calculated, and the at least one inference model in which the calculated distance is equal to or less than a threshold may be identified from among the plurality of inference models.

According to this configuration, the inference model machine-learned using the training data set similar to the at least one piece of inference target data can be identified as an inference model suitable for the at least one piece of inference target data. In addition, it is possible to easily identify the candidate of the inference model by using the distance between the first representative feature vector of the at least one piece of inference target data and the second representative feature vector of each of the plurality of training data sets.

(4) In the information processing method according to (1), in the acquiring of the at least one piece of inference target data, an inference target data set including a plurality of pieces of inference target data may be acquired, and in the identifying of the at least one inference model, an inter-distribution distance between the acquired inference target data set and each of a plurality of training data sets used when machine learning is performed on each of the plurality of inference models is calculated, and the at least one inference model in which the calculated inter-distribution distance is equal to or less than a threshold may be identified from among the plurality of inference models.

According to this configuration, the inference model machine-learned using the training data set similar to the inference target data set can be identified as an inference model suitable for the inference target data set. In addition, it is possible to easily identify a candidate of the inference model by using the inter-distribution distance between the inference target data set and each of the plurality of training data sets.

(5) In the information processing method according to (1), in the identifying of the at least one inference model, a matching degree of each of the plurality of inference models with respect to the acquired at least one piece of inference target data may be calculated, and the at least one inference model of which the calculated matching degree is equal to or greater than a threshold may be identified from among the plurality of inference models.

According to this configuration, the matching degree of each of the plurality of inference models with respect to the acquired at least one piece of inference target data is calculated, and at least one inference model whose calculated matching degree is equal to or greater than a threshold is identified from among the plurality of inference models. Therefore, it is possible to easily identify a candidate of the inference model.

(6) In the information processing method according to (2), each of the plurality of inference models may be assigned with a name, and in the identifying of the at least one inference model, the at least one inference model including the acquired at least one keyword in the name may be identified from among the plurality of inference models.

According to this configuration, it is possible to easily identify a candidate of the inference model from the name of the inference model.

(7) In the information processing method according to (2), a word related to an inference model may be associated with each of the plurality of inference models as a tag, and in the identifying of the at least one inference model, the at least one inference model associated with the tag including the acquired at least one keyword may be identified from among the plurality of inference models.

According to this configuration, it is possible to easily identify the candidate of the inference model from the word related to the inference model associated with the inference model as the tag.

(8) In the information processing method according to (2), in the identifying of the at least one inference model, a first word vector obtained by vectorizing the acquired at least one keyword may be calculated, a plurality of second word vectors obtained by vectorizing at least one word included in a name of each of the plurality of inference models or at least one word related to an inference model associated with each of the plurality of inference models as a tag may be calculated, a distance between the calculated first word vector and each of the plurality of calculated second word vectors may be calculated, and the at least one inference model in which the calculated distance is equal to or less than a threshold may be identified from among the plurality of inference models.

According to this configuration, the inference model in which at least one word similar to at least one keyword is included in the name or tag can be identified as the inference model suitable for the at least one keyword. In addition, it is possible to easily identify the candidate of the inference model by using the distance between the first word vector obtained by vectorizing at least one keyword and each of the plurality of second word vectors obtained by vectorizing at least one word included in the name of each of the plurality of inference models or at least one word associated as a tag with each of the plurality of inference models.

(9) In the information processing method according to (2), in the identifying of the at least one inference model, a matching degree of each of the plurality of inference models with respect to the acquired at least one keyword may be calculated, and the at least one inference model of which the calculated matching degree is equal to or greater than a threshold may be identified from among the plurality of inference models.

According to this configuration, the matching degree of each of the plurality of inference models with respect to the acquired at least one keyword is calculated, and at least one inference model whose calculated matching degree is equal to or greater than a threshold is identified from among the plurality of inference models. Therefore, it is possible to easily identify a candidate of the inference model.

(10) In the information processing method according to any one of (1) to (9), in the creating of the presentation screen, the presentation screen for displaying a list of names of the identified at least one inference model may be created.

According to this configuration, since the name of the identified at least one inference model is displayed in a list, it is possible to efficiently narrow down the candidates of the machine-learned inference models suitable for the inference target data without actually inputting the inference target data to the inference model.

(11) In the information processing method according to any one of (1) to (9), in the creating of the presentation screen, the presentation screen for displaying a list of names of the identified at least one inference model together with the matching degree may be created.

According to this configuration, since the name of the identified at least one inference model is displayed in a list together with the matching degree, it is possible to efficiently narrow down the candidates of the machine-learned inference models suitable for the inference target data without actually inputting the inference target data to the inference model. In addition, since the matching degree of at least one inference model to the inference target data is displayed, the user can easily select the optimal inference model by confirming the displayed matching degree.

(12) In the information processing method according to any one of (1) to (9), in the creating of the presentation screen, the presentation screen for displaying a list of the identified at least one inference model in a selectable state for each use environment and displaying a list of inference models corresponding to the selected use environment for each use location may be created.

According to this configuration, the identified at least one inference model is displayed in a list in a selectable state for each use environment, and the inference model corresponding to the selected use environment is displayed in a list for each use location. Therefore, since at least one inference model suitable for the inference target data set is displayed hierarchically, the user can easily select the inference model even in a case where there are a large number of candidates of the inference model.

(13) In the information processing method according to any one of (1) to (9), in the creating of the presentation screen, the presentation screen for displaying a list of names of a plurality of inference tasks that can be inferred by the at least one inference model in a selectable state and displaying a list of names of the at least one inference model corresponding to a selected inference task may be created.

According to this configuration, names of a plurality of inference tasks that can be inferred by at least one inference model are displayed in a list form in a selectable state, and names of at least one inference model corresponding to the selected inference task are displayed in a list form. Therefore, the user can recognize the available inference task from the inference target data, and can select the inference model corresponding to the selected inference task.

(14) In the information processing method according to any one of (1) to (9), in the creating of the presentation screen, the presentation screen for displaying a list of names of the identified at least one inference model in a selectable state, displaying a list of names of at least one piece of inference target data in a selectable state, and in a case where any one of the names of the at least one inference model is selected and any one of the names of the at least one piece of inference target data is selected, displaying an inference result obtained by inferring the selected inference target data by the selected inference model may be created.

According to this configuration, since the inference result is simply displayed, it is possible to redesign the arrangement position of the camera for acquiring the inference target data and the illumination environment of the space in which the camera is arranged.

Furthermore, in a case where a plurality of inference models is selected, the inference result of each of the plurality of selected models is displayed. Therefore, the user can intuitively compare the inference results of the plurality of selected inference models, and can contribute to the selection of the inference model by the user.

In addition, since at least one inference model, at least one piece of inference target data, and an inference result are displayed on one screen, an operation when the inference model or the inference target data is partially changed and inferred again is simplified.

(15) In the information processing method according to any one of (1) to (9), in the creating of the presentation screen, a first presentation screen for displaying a list of names of the identified at least one inference model in a selectable state may be created, a second presentation screen for displaying a list of names of at least one piece of inference target data in a selectable state may be created in a case where any one of the names of the at least one inference model is selected, and in a case where any one of the names of the at least one piece of inference target data is selected, a third presentation screen for displaying an inference result obtained by inferring the inference target data selected on the second presentation screen by the inference model selected on the first presentation screen may be created.

According to this configuration, since the inference result is simply displayed, it is possible to redesign the arrangement position of the camera for acquiring the inference target data and the illumination environment of the space in which the camera is arranged. Furthermore, in a case where a plurality of inference models is selected, the inference result of each of the plurality of selected models is displayed. Therefore, the user can intuitively compare the inference results of the plurality of selected inference models, and can contribute to the selection of the inference model by the user.

In addition, since the name of the at least one inference model, the name of the at least one piece of inference target data, and the inference result can be individually displayed on the entire screen, the visibility and operability of the user can be improved.

Further, the present disclosure can be implemented not only as an information processing method for executing the characteristic processing as described above, but also as an information processing device or the like having a characteristic configuration corresponding to characteristic processing executed by the information processing method. Further, the present disclosure can also be implemented as a computer program that causes a computer to execute characteristic processing included in the information processing method described above. Therefore, even in another aspect below, an effect as in the above information processing method can be achieved.

(16) An information processing device according to another aspect of the present disclosure includes: an acquisition part that acquires at least one piece of inference target data; an identification part that identifies at least one inference model according to the at least one piece of inference target data from among a plurality of inference models that output an inference result using the inference target data as an input; a creation part that creates a presentation screen for presenting the identified at least one inference model to a user; and an output part that outputs the created presentation screen.

(17) An information processing program according to another aspect of the present disclosure causes a computer to execute: acquiring at least one piece of inference target data; identifying at least one inference model according to the at least one piece of inference target data from among a plurality of inference models that output an inference result using the inference target data as an input; creating a presentation screen for presenting the identified at least one inference model to a user; and outputting the created presentation screen.

(18) An information processing device according to another aspect of the present disclosure includes: an acquisition part that acquires at least one keyword; an identification part that identifies at least one inference model according to the at least one keyword from among a plurality of inference models that output an inference result using inference target data as an input; a creation part that creates a presentation screen for presenting the identified at least one inference model to a user; and an output part that outputs the created presentation screen.

(19) An information processing program according to another aspect of the present disclosure causes a computer to execute: acquiring at least one keyword; identifying at least one inference model according to the at least one keyword from among a plurality of inference models that output an inference result using inference target data as an input; creating a presentation screen for presenting the identified at least one inference model to a user; and outputting the created presentation screen.

(20) A computer-readable recording medium according to another aspect of the present disclosure records an information processing program, the information processing program causing a computer to function: acquiring at least one piece of inference target data; identifying at least one inference model according to the at least one piece of inference target data from among a plurality of inference models that output an inference result using the inference target data as an input; creating a presentation screen for presenting the identified at least one inference model to a user; and outputting the created presentation screen.

(21) A non-transitory computer-readable recording medium according to another aspect of the present disclosure records an information processing program, the information processing program causing a computer to function: acquiring at least one keyword; identifying at least one inference model according to the at least one keyword from among a plurality of inference models that output an inference result using inference target data as an input; creating a presentation screen for presenting the identified at least one inference model to a user; and outputting the created presentation screen.

Hereinafter, embodiments of the present disclosure will be described with reference to the accompanying drawings. Note that each of embodiments to be described below illustrates a specific example of the present disclosure. Numerical values, shapes, constituent elements, steps, order of steps, and the like of the embodiment below are merely examples, and do not intend to limit the present disclosure. A constituent element not described in an independent claim representing a highest concept among constituent elements in the embodiments below is described as an optional constituent element. In all the embodiments, content of each of the embodiments can be combined.

### First Embodiment

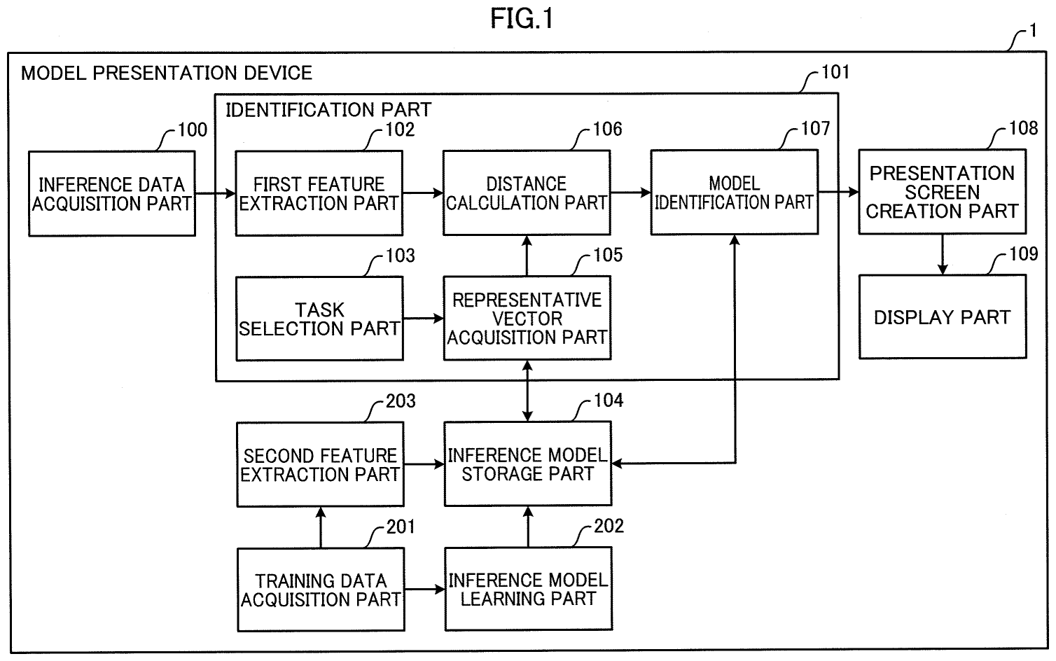

FIG. 1 is a diagram illustrating a configuration of a model presentation device 1 according to a first embodiment of the present disclosure.

The model presentation device 1 illustrated in FIG. 1 includes an inference data acquisition part 100, an identification part 101, an inference model storage part 104, a presentation screen creation part 108, a display part 109, a training data acquisition part 201, an inference model learning part 202, and a second feature extraction part 203.

The inference data acquisition part 100, the identification part 101, the presentation screen creation part 108, the training data acquisition part 201, the inference model learning part 202, and the second feature extraction part 203 are realized by a processor. The processor includes, for example, a central processing unit (CPU) or the like.

The inference model storage part 104 is implemented by a memory. The memory includes, for example, a read only memory (ROM), an electrically erasable programmable read only memory (EEPROM), or the like.

The inference data acquisition part 100 acquires at least one piece of inference target data for performing inference. The inference target data is, for example, image data captured in a use scene for which the user desires to perform inference. For example, in a case where the person detection is performed in a predetermined environment, the inference target data is image data captured in a predetermined environment. Furthermore, for example, in a case where the person detection is performed at a predetermined place, the inference target data is image data captured at a predetermined place. The inference data acquisition part 100 acquires an inference target data set including a plurality of pieces of inference target data. The inference data acquisition part 100 may acquire all the inference target data in the inference target data set, may acquire some inference target data in the inference target data set, or may acquire one piece of inference target data. Note that the inference target data may be, for example, voice data.

The inference data acquisition part 100 may acquire the inference target data set from the memory based on an instruction from an input part (not illustrated), or may acquire the inference target data set from an external device via a network. The input part is, for example, a keyboard, a mouse, and a touch panel. The external device is a server, an external storage device, a camera, or the like.

The identification part 101 identifies at least one inference model corresponding to the at least one piece of inference target data acquired by the inference data acquisition part 100 from among a plurality of inference models that output an inference result using the inference target data as an input.

The identification part 101 includes a first feature extraction part 102, a task selection part 103, a representative vector acquisition part 105, a distance calculation part 106, and a model identification part 107.

The first feature extraction part 102 extracts a first representative feature vector of at least one piece of inference target data acquired by the inference data acquisition part 100. The first feature extraction part 102 has a feature extraction model that outputs a feature vector of each of at least one piece of inference target data using at least one piece of inference target data as an input. The feature extraction model is, for example, a foundation model or a neural network model, and is created by machine learning.

The first feature extraction part 102 inputs the inference target data set acquired by the inference data acquisition part 100 to the feature extraction model, and extracts each feature vector of a plurality of pieces of inference target data included in the inference target data set from the feature extraction model. Then, the first feature extraction part 102 calculates an average of a plurality of feature vectors extracted from the feature extraction model as a first representative feature vector. In a case where one piece of inference target data is acquired by the inference data acquisition part 100, the first feature extraction part 102 calculates one feature vector extracted from the feature extraction model as a first representative feature vector. The task selection part 103 selects an inference task to be executed by the inference model. The inference task includes, for example, motion recognition for recognizing a motion of a person, posture estimation for estimating a posture of a person, person detection for detecting a person, and attribute estimation for estimating attributes such as a type of clothes. For example, an inference model in which the inference task is person detection outputs an inference result in which a bounding box surrounding a person to be detected is superimposed on inference target data. The bounding box is a rectangular frame.

The task selection part 103 may select at least one inference task among the plurality of inference tasks based on an instruction from an input part (not illustrated). The input part may receive selection of an inference task by the user. The user selects a desired inference task from among the plurality of inference tasks.

Note that the task selection part 103 may not select the inference task.

The inference model storage part 104 stores in advance a plurality of inference tasks, a plurality of machine-learned inference models, and a second representative feature vector of each of a plurality of training data sets used when machine learning is performed on each of the plurality of inference models in association with each other.

The representative vector acquisition part 105 acquires the second representative feature vector of each of the plurality of inference models associated with the inference task selected by the task selection part 103 from the inference model storage part 104. Note that, in a case where the inference task is not selected by the task selection part 103, the representative vector acquisition part 105 acquires the second representative feature vectors of all the inference models stored in the inference model storage part 104 from the inference model storage part 104.

The distance calculation part 106 calculates a distance between the first representative feature vector extracted by the first feature extraction part 102 and the second representative feature vector of each of the plurality of training data sets used for machine learning of each of the plurality of inference models. The distance calculation part 106 calculates a distance between the first representative feature vector extracted by the first feature extraction part 102 and each of the plurality of second representative feature vectors acquired by the representative vector acquisition part 105.

The model identification part 107 identifies, from among the plurality of inference models, at least one inference model whose distance calculated by the distance calculation part 106 is equal to or less than a threshold.

The presentation screen creation part 108 creates a presentation screen for presenting the at least one inference model identified by the identification part 101 to the user. The presentation screen creation part 108 creates a presentation screen for displaying a list of names of at least one inference model identified by the identification part 101. Note that the presentation screen creation part 108 may create a presentation screen for displaying a list of the names of the identified at least one inference model in ascending order of the calculated distances.

The display part 109 is, for example, a liquid crystal display device. The display part 109 is one example of an output part. The display part 109 outputs the presentation screen created by the presentation screen creation part 108. The display part 109 displays the presentation screen. In the present first embodiment, the model presentation device 1 includes the display part 109. However, the present disclosure is not particularly limited to this. The display part 109 may be provided outside the model presentation device 1.

The training data acquisition part 201 acquires a training data set corresponding to an inference model for performing machine learning. The training data set includes a plurality of pieces of training data and correct answer information (annotation information) corresponding to each of the plurality of pieces of training data. The training data is, for example, image data corresponding to an inference model for performing machine learning. The correct answer information is different for each inference task. For example, when the inference task is person detection, the correct answer information is a bounding box representing a region occupied by a detection target in the image. In addition, for example, when the inference task is object identification, the correct answer information is a classification result. Further, for example, when the inference task is a region division on an image, the correct answer information is classification information on each pixel. Furthermore, for example, when the inference task is posture estimation, the correct answer information is information indicating the skeleton of the person. Furthermore, for example, when the inference task is attribute estimation, the correct answer information is information indicating an attribute. Note that the training data may be, for example, voice data.

The training data acquisition part 201 may acquire a training data set from a memory based on an instruction from an input part (not illustrated), or may acquire a training data set from an external device via a network. The input part is, for example, a keyboard, a mouse, and a touch panel. The external device is a server, an external storage device, or the like.

The inference model learning part 202 performs machine learning of the inference model using the training data set acquired by the training data acquisition part 201. The inference model learning part 202 performs machine learning of a plurality of inference models. The inference model is a machine learning model using a neural network such as deep learning, but may be another machine learning model. For example, the inference model may be a machine learning model using random forest, genetic programming, or the like.

The machine learning in the inference model learning part 202 is implemented by, for example, a back propagation (BP) method in deep learning or the like. Specifically, the inference model learning part 202 inputs training data to the inference model and acquires an inference result output by the inference model. Then, the inference model learning part 202 adjusts the inference model so that the inference result becomes the correct answer information. The inference model learning part 202 repeats adjustment of the inference model for a plurality of sets (for example, several thousand sets) of different training data and correct answer information to improve the inference accuracy of the inference model.

The inference model learning part 202 stores a plurality of machine-learned inference models in the inference model storage part 104.

The second feature extraction part 203 extracts a second representative feature vector of the training data set acquired by the training data acquisition part 201. The second feature extraction part 203 has a feature extraction model that outputs a feature vector of each of a plurality of pieces of training data using the plurality of pieces of training data included in the training data sets as inputs. The feature extraction model is, for example, a foundation model or a neural network model, and is created by machine learning.

The second feature extraction part 203 inputs the training data set acquired by the training data acquisition part 201 to the feature extraction model, and extracts each feature vector of a plurality of pieces of training data included in the training data set from the feature extraction model. Then, the second feature extraction part 203 calculates an average of the plurality of feature vectors extracted from the feature extraction model as a second representative feature vector. The second feature extraction part 203 calculates a second representative feature vector of each of the plurality of inference models.

The second feature extraction part 203 stores each of the plurality of extracted second representative feature vectors in the inference model storage part 104 in association with each of the plurality of machine-learned inference models.

Note that, in the first embodiment, the model presentation device 1 includes the training data acquisition part 201, the inference model learning part 202, and the second feature extraction part 203, but the present disclosure is not particularly limited thereto. The model presentation device 1 may not include the training data acquisition part 201, the inference model learning part 202, and the second feature extraction part 203, and an external computer connected to the model presentation device 1 via a network may include the training data acquisition part 201, the inference model learning part 202, and the second feature extraction part 203. In this case, the model presentation device 1 may further include a communication part that receives a plurality of machine-learned inference models from an external computer and stores the received plurality of inference models in the inference model storage part 104.

Next, machine learning processing in the model presentation device 1 according to the first embodiment of the present disclosure will be described.

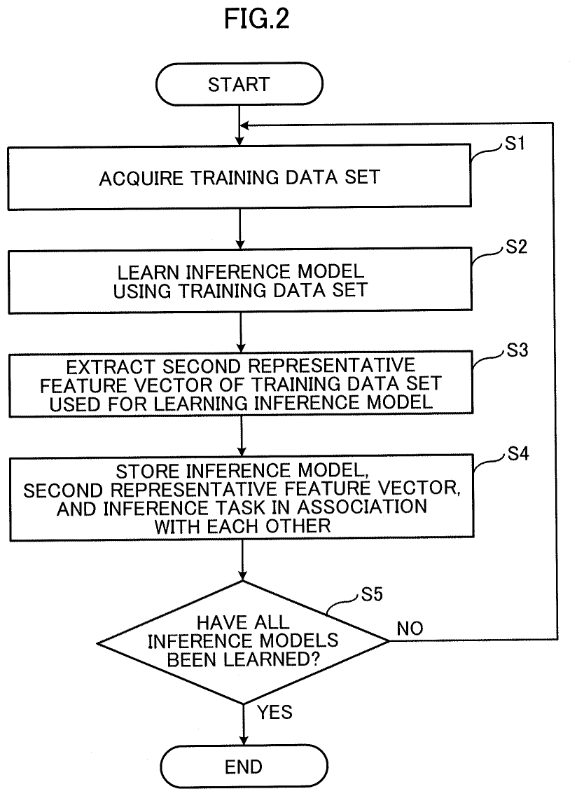

FIG. 2 is a flowchart for explaining machine learning processing in the model presentation device 1 according to the first embodiment of the present disclosure.

First, in step S1, the training data acquisition part 201 acquires a training data set corresponding to an inference model for performing learning.

Next, in step S2, the inference model learning part 202 learns the inference model using the training data set acquired by the training data acquisition part 201.

Next, in step S3, the second feature extraction part 203 extracts a second representative feature vector of the training data set used for learning of the inference model.

Next, in step S4, the second feature extraction part 203 stores the learned inference model, the second representative feature vector used for learning of the inference model, and the inference task indicating the type of inference performed by the inference model in the inference model storage part 104 in association with each other.

Next, in step S5, the training data acquisition part 201 determines whether all the inference models have been learned. Note that a training data set is prepared for each of the plurality of inference models, and the training data acquisition part 201 may determine that all the inference models have been learned in a case where all the prepared training data sets have been acquired. Here, in a case where it is determined that all the inference models have been learned (YES in step S5), the process ends.

On the other hand, in a case where it is determined that not all the inference models have been learned (NO in step S5), the process returns to step S1, and the training data acquisition part 201 acquires a training data set for learning an unlearned inference model among the plurality of inference models.

Next, model presentation processing in the model presentation device 1 according to the first embodiment of the present disclosure will be described.

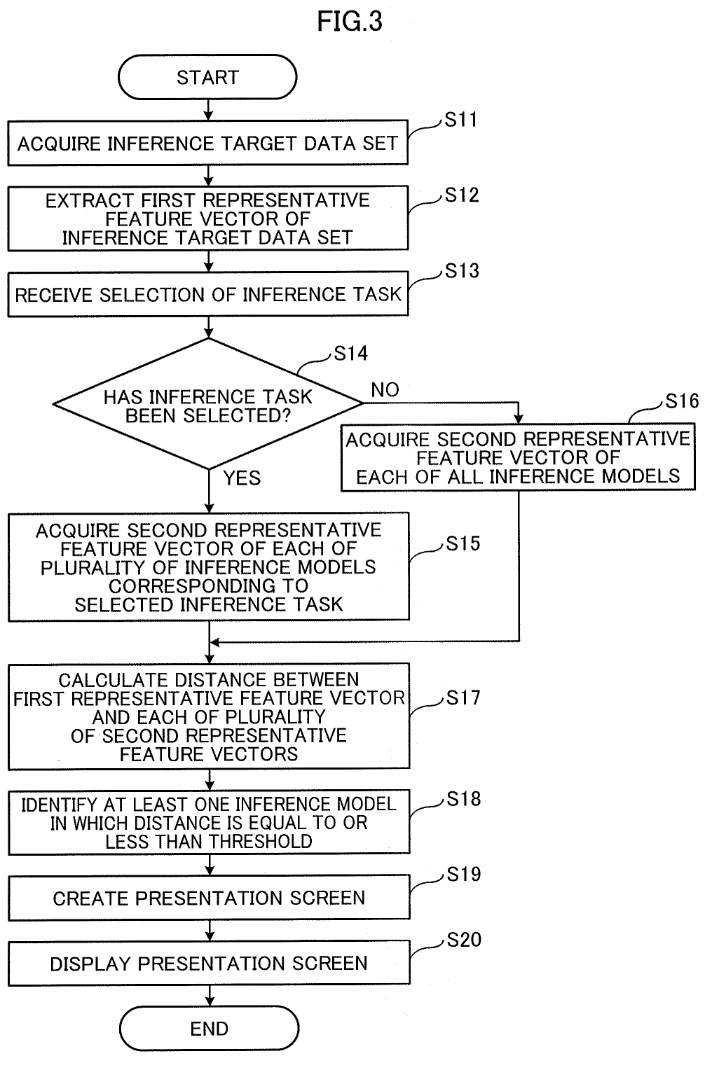

FIG. 3 is a flowchart for explaining model presentation processing in the model presentation device 1 according to the first embodiment of the present disclosure.

First, in step S11, the inference data acquisition part 100 acquires an inference target data set.

Next, in step S12, the first feature extraction part 102 extracts a first representative feature vector of the inference target data set acquired by the inference data acquisition part 100.

Next, in step S13, the task selection part 103 receives selection of an inference task desired by the user from among the plurality of inference tasks. The user selects a desired inference task from among the plurality of inference tasks. By selecting the inference task, the number of inference models can be narrowed down, and the calculation amount can be reduced. Note that, in a case where the user does not know what kind of inference task should be performed, the task selection part 103 may not accept the selection of the inference task and may not select the inference task.

Next, in step S14, the task selection part 103 determines whether an inference task has been selected.

Here, in a case where it is determined that the inference task has been selected (YES in step S14), in step S15, the representative vector acquisition part 105 acquires the second representative feature vector of each of the plurality of inference models corresponding to the inference task selected by the task selection part 103 from the inference model storage part 104.

On the other hand, in a case where it is determined that the inference task has not been selected (NO in step S14), in step S16, the representative vector acquisition part 105 acquires the second representative feature vectors of all the inference models from the inference model storage part 104.

Next, in step S17, the distance calculation part 106 calculates a distance between the first representative feature vector extracted by the first feature extraction part 102 and each of the plurality of second representative feature vectors acquired by the representative vector acquisition part 105.

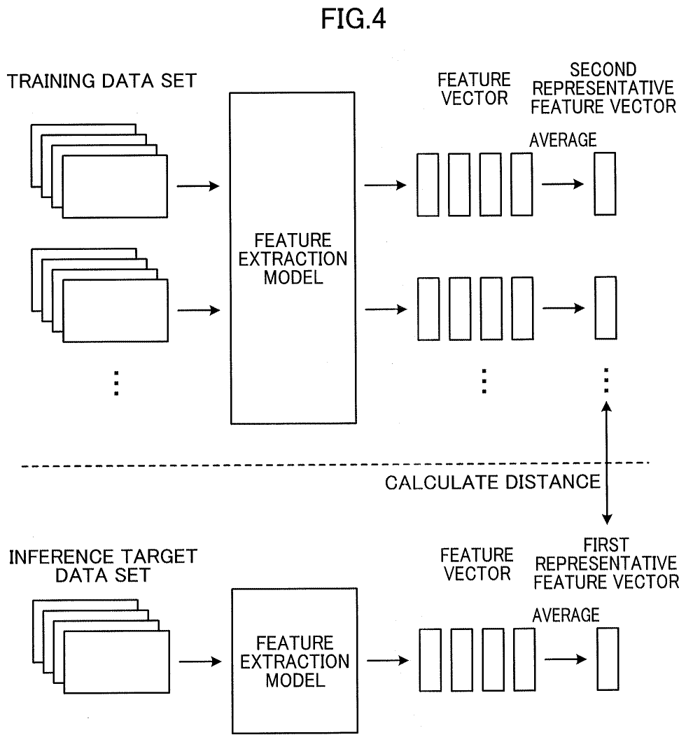

FIG. 4 is a schematic diagram for explaining extraction of a first representative feature vector and a plurality of second representative feature vectors in the first embodiment.

As illustrated in FIG. 4, when the inference target data set is input to the feature extraction model, the feature extraction model outputs a feature vector of each of a plurality of pieces of inference target data included in the inference target data set. Then, the first feature extraction part 102 calculates an average of the plurality of feature vectors as a first representative feature vector.

In addition, when the training data set is input to the feature extraction model, the feature extraction model outputs a feature vector of each of a plurality of pieces of training data included in the training data set. Then, the second feature extraction part 203 calculates an average of the plurality of feature vectors as a second representative feature vector.

The distance calculation part 106 calculates a distance between the first representative feature vector and each of the plurality of second representative feature vectors. The shorter the distance, the higher the similarity between the inference target data set and the training data set. Therefore, it can be said that the inference model associated with the second representative feature vector having the distance equal to or less than the threshold is an inference model suitable for inference of the inference target data set.

Returning to FIG. 3, next, in step S18, the model identification part 107 identifies, from among the plurality of inference models, at least one inference model whose distance calculated by the distance calculation part 106 is equal to or less than a threshold.

Next, in step S19, the presentation screen creation part 108 creates a presentation screen for presenting the at least one inference model identified by the identification part 101 to the user.

Next, in step S20, the display part 109 displays the presentation screen created by the presentation screen creation part 108.

In this manner, at least one piece of inference target data is acquired, at least one inference model corresponding to the acquired at least one piece of inference target data is identified from among a plurality of inference models that output an inference result using the inference target data as an input, and the identified at least one inference model is presented to the user.

Therefore, it is possible to present a candidate of an inference model suitable for the use scene to the user based on the acquired at least one piece of inference target data, and it is possible to reduce the cost and time required from selection to introduction of an inference model for inferring the inference target data.

Note that, in the first embodiment, the model identification part 107 identifies, from among a plurality of inference models, at least one inference model whose distance calculated by the distance calculation part 106 is equal to or less than the threshold, but the present disclosure is not particularly limited thereto. The model identification part 107 may identify, from among the plurality of inference models, a predetermined number of inference models in order from among the inference model having the shortest distance calculated by the distance calculation part 106.

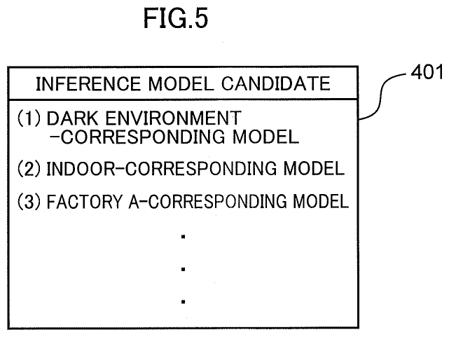

FIG. 5 is a diagram illustrating an example of a presentation screen 401 displayed on the display part 109 in the present first embodiment.

The presentation screen creation part 108 creates the presentation screen 401 for displaying a list of names of at least one inference model identified by the identification part 101.

On the presentation screen 401 illustrated in FIG. 5, the candidates of the inference model suitable for the inference target data set are displayed. The presentation screen 401 displays the names of the inference models in ascending order of the distance calculated by the distance calculation part 106. The presentation screen 401 illustrated in FIG. 5 indicates that the “dark environment-corresponding model” is optimal for the inference target data set, the “indoor-corresponding model” is second most suitable for the inference target data set, and the “factory A-corresponding model” is third most suitable for the inference target data set.

In this manner, since the names of at least one inference model suitable for the inference target data set are displayed in a list, it is possible to efficiently narrow down the candidates of the machine-learned inference models suitable for the inference target data set without actually inputting the inference target data set to the inference model.

Note that the user selects and determines an inference model to be actually used for inference of the inference target data set from among the presented at least one inference model.

Note that the presentation screen can be variously changed. Hereinafter, a modification of the presentation screen will be described.

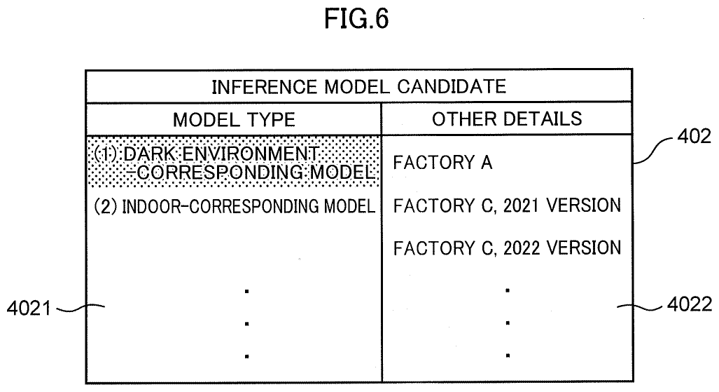

FIG. 6 is a diagram illustrating an example of a presentation screen 402 displayed on the display part 109 in a first modification of the first embodiment.

The presentation screen creation part 108 may create the presentation screen 402 for displaying a list of at least one inference model identified by the identification part 101 in a selectable state for each use environment and displaying a list of inference models corresponding to the selected use environment for each use location.

The presentation screen 402 illustrated in FIG. 6 includes a first display area 4021 for displaying a list of at least one inference model identified by the identification part 101 in a selectable state for each use environment, and a second display area 4022 for displaying a list of inference models corresponding to the selected use environment for each use location.

In the first display area 4021, the type of inference model suitable for the inference target data set is displayed. The type of the inference model represents a use environment of the inference model. The first display area 4021 displays the type names of the inference models in ascending order of the distance calculated by the distance calculation part 106. The first display area 4021 illustrated in FIG. 6 indicates that the “dark environment-corresponding model” is optimal for the inference target data set and the “indoor-corresponding model” is second most suitable for the inference target data set.

Types of the plurality of inference models in the first display area 4021 can be selected. An input part (not illustrated) receives selection by any user of the types of the plurality of displayed inference models. When any one of the types of the plurality of inference models is selected, a plurality of inference models corresponding to the selected type of the inference model is displayed in the second display area 4022 of the presentation screen 402 for each use location.

For example, in a case where the “dark environment-corresponding model” of the first display area 4021 is selected, an inference model corresponding to the “factory A”, an inference model corresponding to the “factory C, 2021 version”, and an inference model corresponding to the “factory C, 2022 version” are displayed in the second display area 4022. The “2021 version” represents an inference model created in 2021.

Note that the second representative feature vectors of the inference models of the upper layer displayed in the first display area 4021 may be calculated using the second representative feature vectors of all the inference models of the lower layer. That is, the second representative feature vector of the inference model of the upper layer displayed in the first display area 4021 may be an average of the second representative feature vectors of the inference models of the lower layer. The inference models of the first display area 4021 and the second display area 4022 are displayed in ascending order of distance.

As described above, since at least one inference model suitable for the inference target data set is displayed hierarchically, the user can easily select the inference model even in a case where there are a large number of candidates of the inference model.

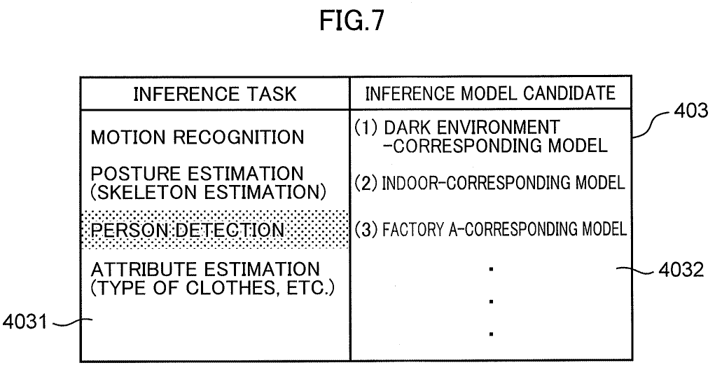

FIG. 7 is a diagram illustrating an example of a presentation screen 403 displayed on the display part 109 in a second modification of the first embodiment.

The presentation screen creation part 108 may create the presentation screen 403 for displaying a list of names of a plurality of inference tasks that can be inferred by at least one inference model in a selectable state and displaying a list of names of at least one inference model corresponding to the selected inference task. In particular, in a case where the inference task is not selected by the task selection part 103, the presentation screen creation part 108 may create the presentation screen 403.

The presentation screen 403 illustrated in FIG. 7 includes a first display area 4031 for displaying a list of names of a plurality of inference tasks that can be inferred by at least one inference model in a selectable state, and a second display area 4032 for displaying a list of names of at least one inference model corresponding to the selected inference task.

In the first display area 4031, names of a plurality of inference tasks are displayed. The names of the plurality of inference tasks in the first display area 4031 can be selected. An input part (not illustrated) receives selection by any user of the names of the plurality of displayed inference tasks. When any one of the names of the plurality of inference tasks is selected, the name of at least one inference model corresponding to the name of the selected inference task is displayed in the second display area 4032 of the presentation screen 403. In the first display area 4031 illustrated in FIG. 7, “person detection” is selected among the names of a plurality of inference tasks.

In the second display area 4032 of the presentation screen 403 illustrated in FIG. 7, the candidates of the inference model corresponding to the name of the selected inference task and suitable for the inference target data set are displayed. The second display area 4032 displays the names of the inference models in ascending order of the distance calculated by the distance calculation part 106. The second display area 4032 illustrated in FIG. 7 indicates that the “dark environment-corresponding model” is optimal for the inference target data set, the “indoor-corresponding model” is second most suitable for the inference target data set, and the “factory A-corresponding model” is third most suitable for the inference target data set.

In this manner, names of a plurality of inference tasks that can be inferred by at least one inference model are displayed in a list form in a selectable state, and names of at least one inference model corresponding to the selected inference task are displayed in a list form. Therefore, the user can recognize the available inference task from the inference target data set, and can select the inference model corresponding to the selected inference task.

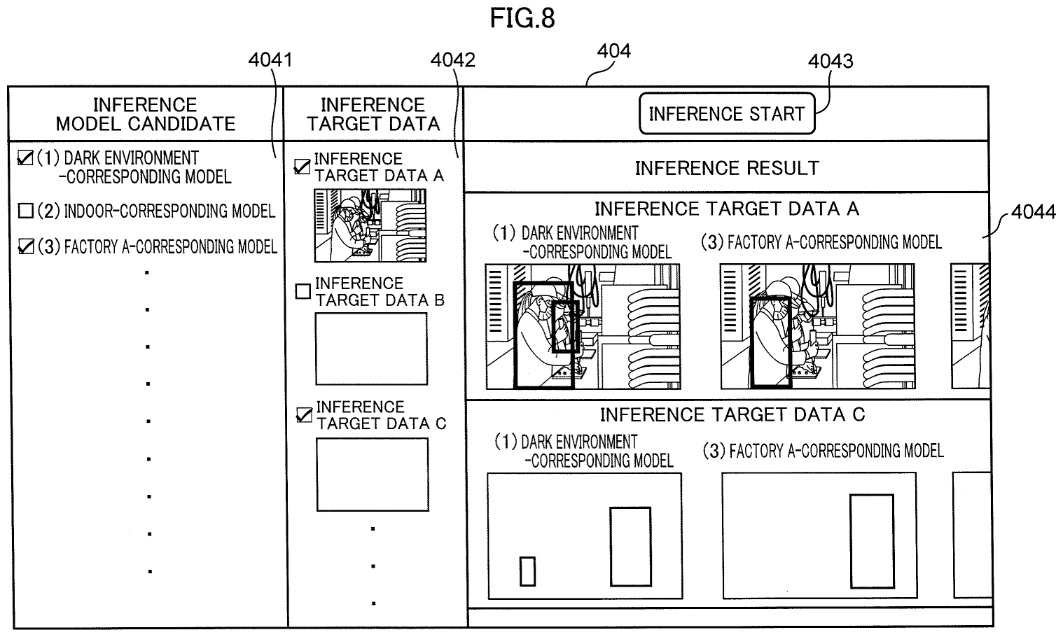

FIG. 8 is a diagram illustrating an example of a presentation screen 404 displayed on the display part 109 in a third modification of the first embodiment.

The presentation screen creation part 108 may create the presentation screen 404 for displaying a list of names of at least one inference model identified by the identification part 101 in a selectable state, displaying a list of names of at least one piece of inference target data in a selectable state, and displaying an inference result obtained by inferring the selected inference target data by the selected inference model in a case where any one of the names of the at least one inference model is selected and any one of the names of the at least one piece of inference target data is selected.

The presentation screen 404 illustrated in FIG. 8 includes a first display area 4041 for displaying a list of names of at least one inference model identified by the identification part 101 in a selectable state, a second display area 4042 for displaying a list of names of at least one piece of inference target data acquired by the inference data acquisition part 100 in a selectable state, an inference start button 4043 for starting inference by the selected inference model, and a third display area 4044 for displaying an inference result obtained by inferring the selected inference target data by the selected inference model.

In the first display area 4041, a check box is displayed in the vicinity of each name of at least one inference model. An input part (not illustrated) receives selection by the user of a check box in the vicinity of the name of the desired inference model. As a result, selection of the name of at least one inference model by the user is accepted.

In the second display area 4042, a check box is displayed in the vicinity of each name of at least one piece of inference target data. An input part (not illustrated) receives selection by the user of a check box in the vicinity of the name of the desired inference target data. As a result, selection of the name of at least one piece of inference target data by the user is accepted.

When both the inference model and the inference target data are selected, the inference start button 4043 can be pressed. An input part (not illustrated) receives pressing of the inference start button 4043 by the user. In a case where the inference start button 4043 is pressed, the inference part (not illustrated) infers the selected inference target data using the selected inference model.

In the third display area 4044, an inference result obtained by inferring the selected inference target data by the selected inference model is displayed. For example, in the third display area 4044 illustrated in FIG. 8, an inference result obtained by inferring the selected inference target data A and inference target data C by the selected dark environment-corresponding model and factory A-corresponding model is displayed. Note that, since the inference task of the inference model illustrated in FIG. 8 is person detection, a bounding box indicating the position of the person in the inference target data is displayed as the inference result.

In this way, since the inference result is simply displayed, it is possible to redesign the arrangement position of the camera for acquiring the inference target data and the illumination environment of the space in which the camera is arranged. Furthermore, in a case where a plurality of inference models is selected, the inference result of each of the plurality of selected models is displayed. Therefore, the user can intuitively compare the inference results of the plurality of selected inference models, and can contribute to the selection of the inference model by the user.

In addition, since at least one inference model, at least one piece of inference target data, and an inference result are displayed on one screen, an operation when the inference model or the inference target data is partially changed and inferred again is simplified.

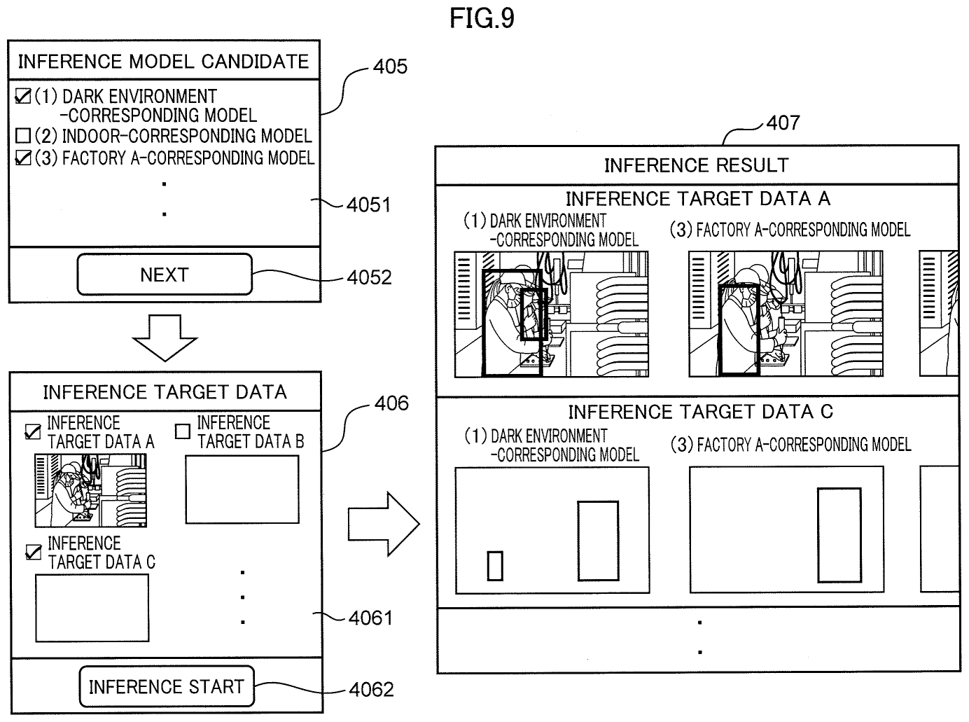

FIG. 9 is a diagram illustrating an example of a first presentation screen 405 to a third presentation screen 407 displayed on the display part 109 in the fourth modification of the present first embodiment.

The presentation screen creation part 108 may create the first presentation screen 405 for displaying a list of names of at least one inference model identified by the identification part 101 in a selectable state. Then, in a case where any one of the names of the at least one inference model is selected, the presentation screen creation part 108 may create the second presentation screen 406 for displaying a list of the names of the at least one piece of inference target data in a selectable state. Then, in a case where any one of the names of at least one piece of inference target data is selected, the presentation screen creation part 108 may create the third presentation screen 407 for displaying the inference result obtained by inferring the inference target data selected on the second presentation screen 406 by the inference model selected on the first presentation screen 405.

First, the display part 109 displays the first presentation screen 405. The first presentation screen 405 illustrated in FIG. 9 includes a first display area 4051 for displaying a list of names of at least one inference model identified by the identification part 101 in a selectable state, and a transition button 4052 for transitioning from the first presentation screen 405 to the second presentation screen 406.

In the first display area 4051, a check box is displayed in the vicinity of each name of at least one inference model. An input part (not illustrated) receives selection by the user of a check box in the vicinity of the name of the desired inference model. As a result, selection of the name of at least one inference model by the user is accepted.

When the inference model is selected, the transition button 4052 can be pressed. An input part (not illustrated) receives pressing of the transition button 4052 by the user. In a case where transition button 4052 is pressed, the display part 109 displays second presentation screen 406.

The second presentation screen 406 illustrated in FIG. 9 includes a second display area 4061 for displaying a list of names of at least one piece of inference target data acquired by the inference data acquisition part 100 in a selectable state, and an inference start button 4062 for starting inference by the selected inference model.

In the second display area 4061, a check box is displayed in the vicinity of each name of at least one piece of inference target data. An input part (not illustrated) receives selection by the user of a check box in the vicinity of the name of the desired inference target data. As a result, selection of the name of at least one piece of inference target data by the user is accepted.

When the inference target data is selected, the inference start button 4062 can be pressed. An input part (not illustrated) receives pressing of the inference start button 4062 by the user. In a case where the inference start button 4062 is pressed, the inference part (not illustrated) infers the selected inference target data using the selected inference model, and the display part 109 displays the third presentation screen 407.

On the third presentation screen 407, an inference result obtained by inferring the selected inference target data by the selected inference model is displayed. For example, an inference result obtained by inferring the selected inference target data A and inference target data C by the selected dark environment-corresponding model and factory A-corresponding model is displayed on the third presentation screen 407 illustrated in FIG. 9. Note that, since the inference task of the inference model illustrated in FIG. 9 is person detection, a bounding box indicating the position of the person in the inference target data is displayed as the inference result.

In this way, since the inference result is simply displayed, it is possible to redesign the arrangement position of the camera for acquiring the inference target data and the illumination environment of the space in which the camera is arranged. Furthermore, in a case where a plurality of inference models is selected, the inference result of each of the plurality of selected models is displayed. Therefore, the user can intuitively compare the inference results of the plurality of selected inference models, and can contribute to the selection of the inference model by the user.

In addition, since the name of the at least one inference model, the name of the at least one piece of inference target data, and the inference result can be individually displayed on the entire screen, the visibility and operability of the user can be improved.

In addition, the display part 109 may display first presentation screen 405, second presentation screen 406, and third presentation screen 407 in an overlapping manner, and switch each screen by a tab. This can further improve the operability of the user.

### Second Embodiment

In the first embodiment, the distance between the representative feature vector of the acquired at least one piece of inference target data and the representative feature vector of each of the plurality of training data sets used for machine learning of each of the plurality of inference models is calculated, and at least one inference model whose calculated distance is equal to or less than a threshold is identified from among the plurality of inference models. On the other hand, in the second embodiment, the inter-distribution distance between the acquired inference target data set and each of the plurality of training data sets used for machine learning of each of the plurality of inference models is calculated, and at least one inference model in which the calculated inter-distribution distance is equal to or less than the threshold is identified from among the plurality of inference models.

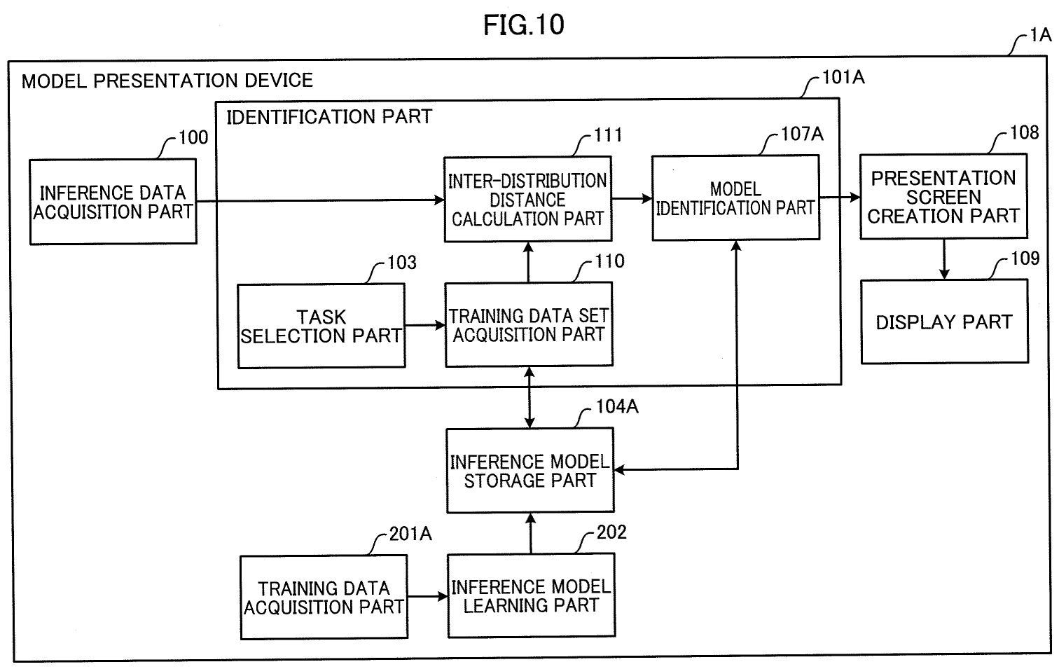

FIG. 10 is a diagram illustrating a configuration of a model presentation device 1A according to the second embodiment of the present disclosure.

The model presentation device 1A illustrated in FIG. 10 includes an inference data acquisition part 100, an identification part 101A, an inference model storage part 104A, a presentation screen creation part 108, a display part 109, a training data acquisition part 201A, and an inference model learning part 202.

The inference data acquisition part 100, the identification part 101A, the presentation screen creation part 108, the training data acquisition part 201A, and the inference model learning part 202 are realized by a processor. The inference model storage part 104A is implemented by a memory.

The identification part 101A includes a task selection part 103, a training data set acquisition part 110, an inter-distribution distance calculation part 111, and a model identification part 107A.

Note that, in the second embodiment, the same configuration as that in the first embodiment will be denoted by the same reference sign as that in the first embodiment, and will be omitted from description.

The inference data acquisition part 100 acquires an inference target data set including a plurality of pieces of inference target data.

The inference model storage part 104A stores in advance a plurality of inference tasks, a plurality of machine-learned inference models, and a plurality of training data sets used when machine learning is performed on each of the plurality of inference models in association with each other.

The training data set acquisition part 110 acquires the training data set of each of the plurality of inference models associated with the inference task selected by the task selection part 103 from the inference model storage part 104A. Note that, in a case where the inference task is not selected by the task selection part 103, the training data set acquisition part 110 acquires the training data set of each of all the inference models stored in the inference model storage part 104A from the inference model storage part 104A.

The inter-distribution distance calculation part 111 calculates an inter-distribution distance between the inference target data set acquired by the inference data acquisition part 100 and each of the plurality of training data sets used when machine learning is performed on each of the plurality of inference models. The inter-distribution distance calculation part 111 calculates an inter-distribution distance between the inference target data set acquired by the inference data acquisition part 100 and each of the plurality of training data sets acquired by the training data set acquisition part 110. The shorter the inter-distribution distance, the higher the similarity between the inference target data set and the training data set. Therefore, it can be said that the inference model associated with the training data set in which the inter-distribution distance is equal to or less than the threshold is an inference model suitable for inference of the inference target data set.

Note that the inter-distribution distance is calculated as an optimal transport problem. A method of calculating the inter-distribution distance is disclosed in, for example, a conventional document (David Alvarez-Melis, Nicolo Fusi, “Geometric Dataset Distances via Optimal Transport”, NIPS'20: Proceedings of the 34th International Conference on Neural Information Processing Systems, December 2020, Article No. 1799, Pages 21428-21439). The inter-distribution distance calculation part 111 calculates the inter-distribution distance between the data sets as the optimal transport problem by using the Euclidean distance as the inter-feature distance and using the Wasserstein distance as the inter-label distance. The inter-distribution distance corresponds to the transport cost of the optimal transport problem. The Sinkhorn algorithm is used for the optimal transport problem. Note that, in a case where the data set is not labeled, the inter-distribution distance calculation part 111 may solve the optimal transport problem using only the inter-feature distance.

The model identification part 107A identifies, from among the plurality of inference models, at least one inference model in which the inter-distribution distance calculated by the inter-distribution distance calculation part 111 is equal to or less than a threshold.

The presentation screen creation part 108 may create a presentation screen for displaying a list of the names of at least one inference model identified by the model identification part 107A in ascending order of the inter-distribution distances calculated by the inter-distribution distance calculation part 111.

The training data acquisition part 201A acquires a training data set corresponding to an inference model for performing machine learning.

The inference model learning part 202 stores each of the plurality of training data sets acquired by the training data acquisition part 201A in the inference model storage part 104A in association with each of the plurality of machine-learned inference models.

Note that, in the second embodiment, the model presentation device 1A includes the training data acquisition part 201A and the inference model learning part 202, but the present disclosure is not particularly limited thereto. The model presentation device 1A may not include the training data acquisition part 201A and the inference model learning part 202, and an external computer connected to the model presentation device 1A via a network may include the training data acquisition part 201A and the inference model learning part 202. In this case, the model presentation device 1A may further include a communication part that receives a plurality of machine-learned inference models from an external computer and stores the received plurality of inference models in the inference model storage part 104A.

Next, machine learning processing in the model presentation device 1A according to the second embodiment of the present disclosure will be described.

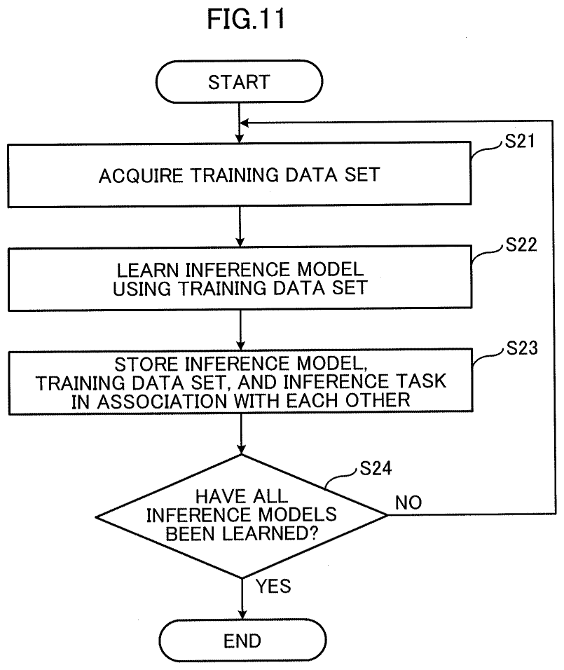

FIG. 11 is a flowchart for explaining machine learning processing in the model presentation device 1A according to the second embodiment of the present disclosure.

Processing in step S21 and step S22 is the same as the processing in step S1 and step S2 of FIG. 2, and will be omitted from description.

Next, in step S23, the inference model learning part 202 stores the learned inference model, the training data set used for learning of the inference model, and the inference task indicating the type of inference performed by the inference model in the inference model storage part 104A in association with each other.

Processing in step S24 is the same as the processing in step S5 illustrated in FIG. 2, and thus will be omitted from description.

Next, model presentation processing in the model presentation device 1A according to the second embodiment of the present disclosure will be described.

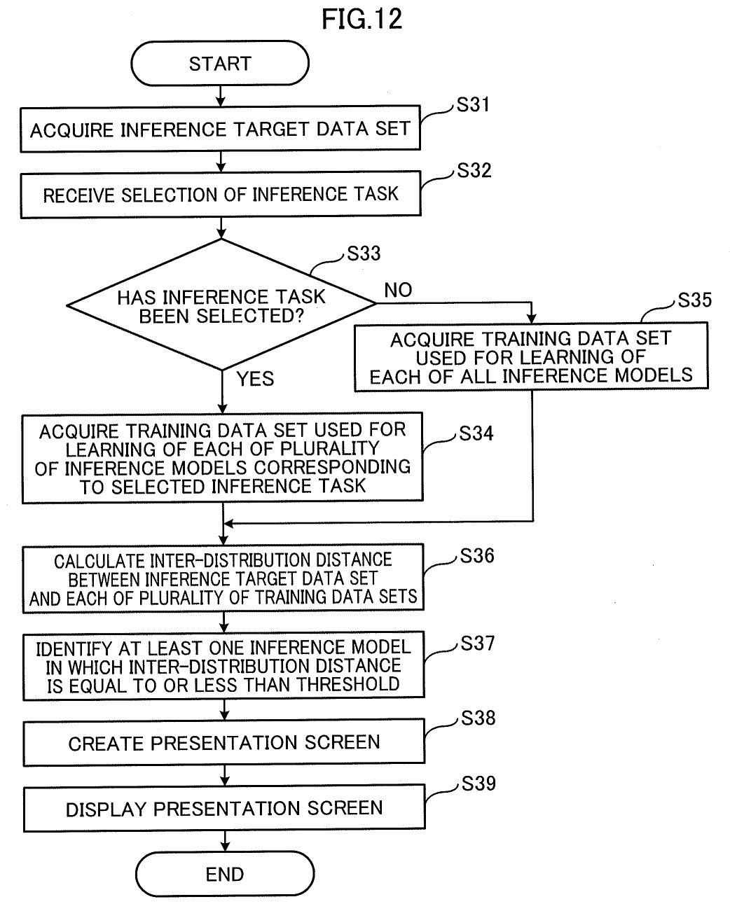

FIG. 12 is a flowchart for explaining model presentation processing in the model presentation device 1A according to the second embodiment of the present disclosure.

Processing in step S31 to step S33 is the same as the processing in step S11, step S13, and step S14 of FIG. 3, and will be omitted from description.

Here, in a case where it is determined that the inference task has been selected (YES in step S33), in step S34, the training data set acquisition part 110 acquires the training data set used for learning of each of the plurality of inference models corresponding to the inference task selected by the task selection part 103 from the inference model storage part 104A.

On the other hand, in a case where it is determined that the inference task has not been selected (NO in step S33), in step S35, the training data set acquisition part 110 acquires the training data set used for learning of each of all the inference models from the inference model storage part 104A.

Next, in step S36, the inter-distribution distance calculation part 111 calculates an inter-distribution distance between the inference target data set acquired by the inference data acquisition part 100 and each of the plurality of training data sets acquired by the training data set acquisition part 110.

Next, in step S37, the model identification part 107A identifies, from among the plurality of inference models, at least one inference model in which the inter-distribution distance calculated by the inter-distribution distance calculation part 111 is equal to or less than a threshold.

Next, in step S38, the presentation screen creation part 108 creates a presentation screen for presenting the at least one inference model identified by the identification part 101A to the user. Note that the presentation screen in the second embodiment is substantially the same as the presentation screens illustrated in FIGS. 5 to 9 in the first embodiment. In the first embodiment, the names of the inference models are displayed in ascending order of the distance calculated by the distance calculation part 106, whereas in the second embodiment, the names of the inference models are displayed in ascending order of the inter-distribution distance calculated by the inter-distribution distance calculation part 111.

Processing in step S39 is the same as the processing in step S20 illustrated in FIG. 3, and thus will be omitted from description.

Note that, in the second embodiment, the model identification part 107A identifies, from among the plurality of inference models, at least one inference model in which the inter-distribution distance calculated by the inter-distribution distance calculation part 111 is equal to or less than the threshold, but the present disclosure is not particularly limited thereto. The model identification part 107A may identify, from among the plurality of inference models, a predetermined number of inference models in order from among the inference model having the shortest inter-distribution distance calculated by the inter-distribution distance calculation part 111.

### Third Embodiment

In the first embodiment, the distance between the representative feature vector of the acquired at least one piece of inference target data and the representative feature vector of each of the plurality of training data sets used for machine learning of each of the plurality of inference models is calculated, and at least one inference model whose calculated distance is equal to or less than a threshold is identified from among the plurality of inference models. On the other hand, in the third embodiment, the matching degree of each of the plurality of inference models with respect to the acquired at least one piece of inference target data is calculated, and at least one inference model whose calculated matching degree is equal to or greater than a threshold is identified from among the plurality of inference models.

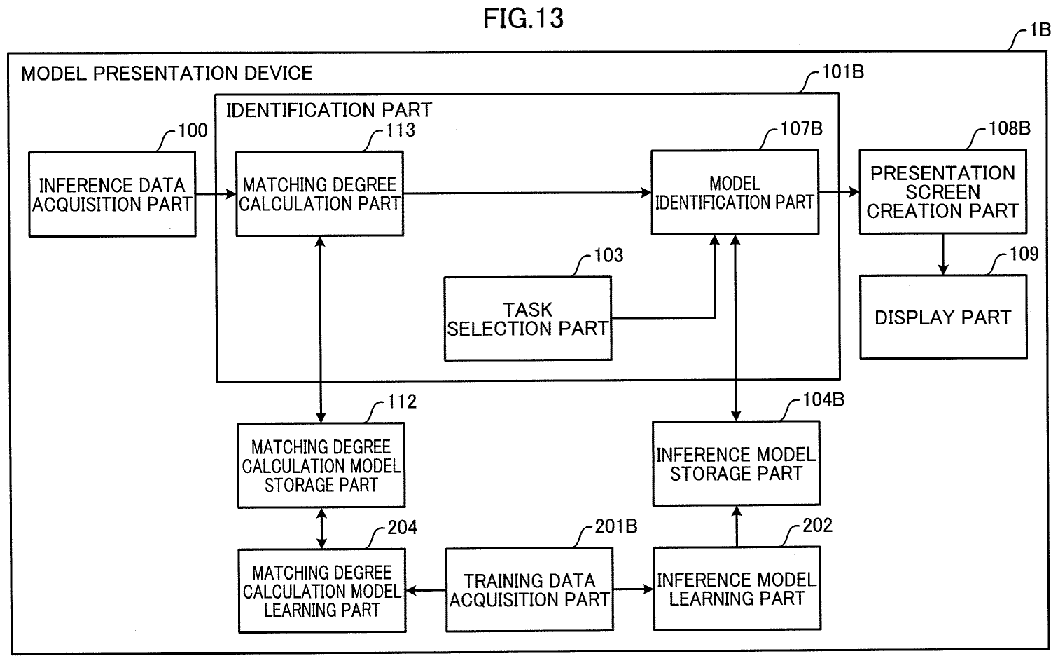

FIG. 13 is a diagram illustrating a configuration of a model presentation device 1B according to the third embodiment of the present disclosure.

The model presentation device 1B illustrated in FIG. 13 includes an inference data acquisition part 100, an identification part 101B, an inference model storage part 104B, a presentation screen creation part 108B, a display part 109, a matching degree calculation model storage part 112, a training data acquisition part 201B, an inference model learning part 202, and a matching degree calculation model learning part 204.

The inference data acquisition part 100, the identification part 101B, the presentation screen creation part 108B, the training data acquisition part 201B, the inference model learning part 202, and the matching degree calculation model learning part 204 are realized by a processor. The inference model storage part 104B and the matching degree calculation model storage part 112 are realized by memories.

The identification part 101B includes a task selection part 103, a model identification part 107B, and a matching degree calculation part 113.

Note that, in the third embodiment, the same configuration as that in the first embodiment will be denoted by the same reference sign as that in the first embodiment, and will be omitted from description.

The inference model storage part 104B stores in advance a plurality of inference tasks and a plurality of machine-learned inference models in association with each other.

The matching degree calculation model storage part 112 stores in advance a matching degree calculation model that outputs the matching degree of each of a plurality of inference models using at least one piece of inference target data as an input.

The matching degree calculation part 113 calculates the matching degree of each of the plurality of inference models with respect to at least one piece of inference target data acquired by the inference data acquisition part 100. The matching degree calculation part 113 inputs at least one piece of inference target data acquired by the inference data acquisition part 100 to the matching degree calculation model, and acquires the matching degree of each of the plurality of inference models with respect to the at least one piece of inference target data from the matching degree calculation model.

The model identification part 107B identifies, from among the plurality of inference models, at least one inference model whose matching degree calculated by the matching degree calculation part 113 is equal to or greater than a threshold.

The presentation screen creation part 108B creates a presentation screen for displaying a list of the names of at least one inference model identified by the model identification part 107B together with the matching degree. At this time, the names of the at least one inference model identified by the model identification part 107B may be displayed in a list in descending order of the calculated matching degree.

The training data acquisition part 201B acquires a training data set corresponding to an inference model for performing machine learning. The training data acquisition part 201B outputs the acquired training data set to the inference model learning part 202. In addition, the training data acquisition part 201B outputs the acquired training data set and information for identifying the inference model to be learned using the training data set to the matching degree calculation model learning part 204.

Note that the training data acquisition part 201B may acquire history information obtained in the past in the first embodiment. In this case, the training data acquisition part 201B may acquire the inference target data set acquired by the inference data acquisition part 100 of the first embodiment, the distance calculated by the distance calculation part 106 of the first embodiment, and the name of the inference model finally identified by the model identification part 107 of the first embodiment.

In addition, the training data acquisition part 201B may acquire history information obtained in the past in the second embodiment. In this case, the training data acquisition part 201B may acquire the inference target data set acquired by the inference data acquisition part 100 of the second embodiment, the inter-distribution distance calculated by the inter-distribution distance calculation part 111 of the second embodiment, and the name of the inference model finally identified by the model identification part 107A of the second embodiment.

The matching degree calculation model learning part 204 performs machine learning of the matching degree calculation model using the training data set acquired by the training data acquisition part 201B. The matching degree calculation model is a machine learning model using a neural network such as deep learning, but may be another machine learning model. For example, the matching degree calculation model may be a machine learning model using random forest, genetic programming, or the like.

The machine learning in the matching degree calculation model learning part 204 is implemented by, for example, a back propagation (BP) method in deep learning or the like. Specifically, the matching degree calculation model learning part 204 inputs the training data set to the matching degree calculation model, and acquires the matching degree for each of the plurality of inference models output by the matching degree calculation model. Then, the matching degree calculation model learning part 204 adjusts the matching degree calculation model such that the matching degree for each of the plurality of inference models becomes the correct answer information. Here, the correct answer information is information in which, among the matching degrees of the plurality of inference models, the matching degree of the inference model using the input training data set for learning is set to 1.0, and the matching degree of another inference model is set to 0.0. The matching degree calculation model learning part 204 improves the matching degree calculation accuracy of the matching degree calculation model by repeating adjustment of the matching degree calculation model for a plurality of sets (for example, thousands of sets) of different training data sets and correct answer information.

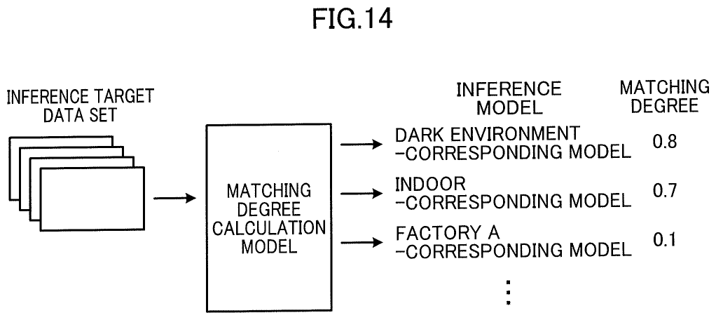

FIG. 14 is a schematic diagram for explaining a matching degree calculation model in the present third embodiment.

The matching degree calculation part 113 inputs the inference target data set acquired by the inference data acquisition part 100 to the matching degree calculation model. When the inference target data set is input, the matching degree calculation model outputs the matching degree of each of the plurality of inference models. The matching degree is expressed, for example, in a range of 1.0 to 0.0. The inference model having the highest matching degree is likely to be an inference model most suitable for inferring the input inference target data set.

For example, in a case where the matching degree of the dark environment-corresponding model is 0.8, the matching degree of the indoor-corresponding model is 0.7, the matching degree of the factory A-corresponding model is 0.1, and the threshold is 0.5, the model identification part 107B identifies the dark environment-corresponding model and the indoor-corresponding model having the matching degree equal to or greater than the threshold from among the plurality of inference models.

In the present third embodiment, the model presentation device 1B includes the training data acquisition part 201B, the inference model learning part 202, and the matching degree calculation model learning part 204, but the present disclosure is not particularly limited thereto. The model presentation device 1B may not include the training data acquisition part 201B, the inference model learning part 202, and the matching degree calculation model learning part 204, and an external computer connected to the model presentation device 1B via a network may include the training data acquisition part 201B, the inference model learning part 202, and the matching degree calculation model learning part 204. In this case, the model presentation device 1B may further include a communication part that receives a plurality of machine-learned inference models and matching degree calculation models from the external computer, stores the plurality of received inference models in the inference model storage part 104B, and stores the received matching degree calculation models in the matching degree calculation model storage part 112.

In addition, the matching degree calculation model learning part 204 may learn the matching degree calculation model by using the history information obtained in the past in the first embodiment acquired by the training data acquisition part 201B. In this case, the matching degree calculation model learning part 204 may normalize the distance calculated by the distance calculation part 106 of the first embodiment, and use the normalized distance for machine learning as correct answer information of the matching degrees of a plurality of inference models.

In addition, the matching degree calculation model learning part 204 may learn the matching degree calculation model by using the history information obtained in the past in the second embodiment acquired by the training data acquisition part 201B. In this case, the matching degree calculation model learning part 204 may normalize the inter-distribution distance calculated by the inter-distribution distance calculation part 111 of the second embodiment, and use the normalized inter-distribution distance for machine learning as correct answer information of the matching degree of a plurality of inference models.

Next, machine learning processing in the model presentation device 1B according to the third embodiment of the present disclosure will be described.

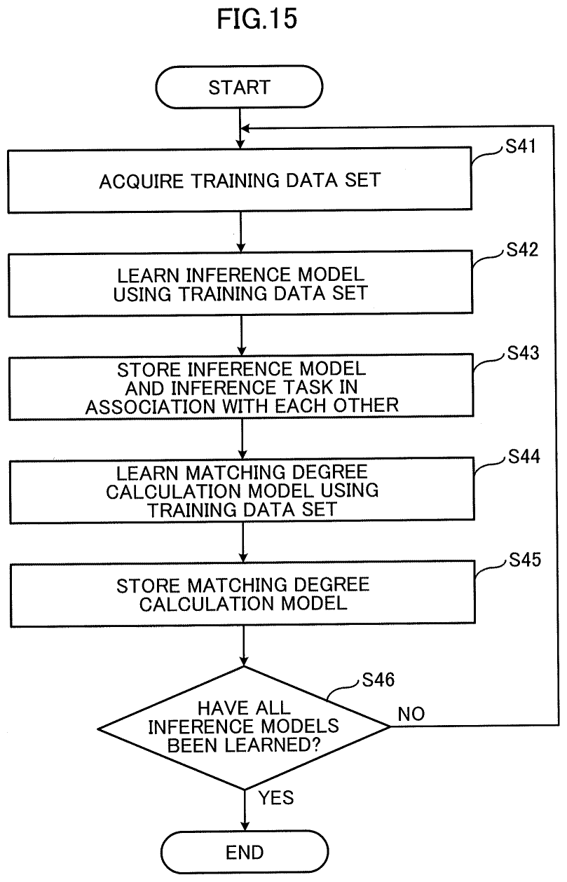

FIG. 15 is a flowchart for explaining machine learning processing in the model presentation device 1B according to the third embodiment of the present disclosure.

Processing in step S41 and step S42 is the same as the processing in step S1 and step S2 of FIG. 2, and will be omitted from description.

Next, in step S43, the inference model learning part 202 stores the learned inference model and the inference task indicating the type of inference performed by the inference model in the inference model storage part 104B in association with each other.

Next, in step S44, the matching degree calculation model learning part 204 learns the matching degree calculation model by using the training data set acquired by the training data acquisition part 201B.

Next, in step S45, the matching degree calculation model learning part 204 stores the learned matching degree calculation model in the matching degree calculation model storage part 112.

Processing in step S46 is the same as the processing in step S5 illustrated in FIG. 2, and thus will be omitted from description.

Note that the processing of steps S41 to S46 is repeated until learning of all the inference models is completed, but in the processing of step S44 of the second and subsequent times, the matching degree calculation model learning part 204 reads the matching degree calculation model stored in the matching degree calculation model storage part 112 and learns the read matching degree calculation model. Then, in the processing of step S45, the matching degree calculation model learning part 204 stores the learned matching degree calculation model again in the matching degree calculation model storage part 112. As a result, the matching degree calculation model stored in the matching degree calculation model storage part 112 is updated, and learning of the matching degree calculation model proceeds.

Next, model presentation processing in the model presentation device 1B according to the third embodiment of the present disclosure will be described.

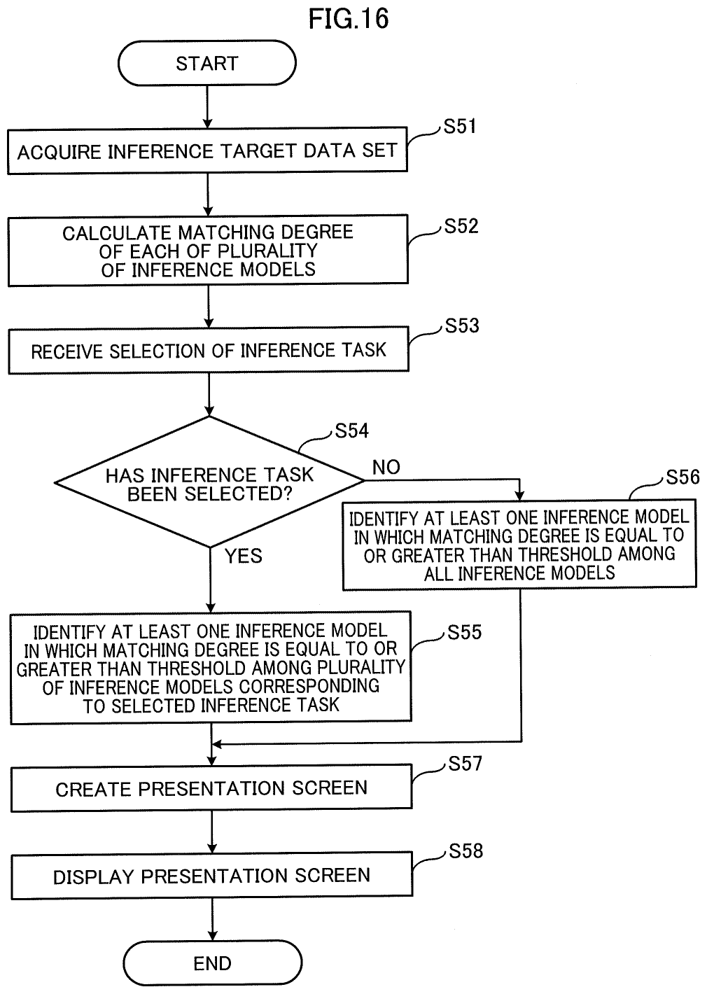

FIG. 16 is a flowchart for explaining model presentation processing in the model presentation device 1B according to the third embodiment of the present disclosure.

Processing in step S51 is the same as the processing in step S11 illustrated in FIG. 3, and thus will be omitted from description.

Next, in step S52, the matching degree calculation part 113 calculates the matching degree of each of the plurality of inference models with respect to the inference target data set acquired by the inference data acquisition part 100. The matching degree calculation part 113 inputs at least one piece of inference target data included in the inference target data set acquired by the inference data acquisition part 100 to the matching degree calculation model, and acquires the matching degree of each of the plurality of inference models with respect to the at least one piece of inference target data from the matching degree calculation model.

Processing in step S53 and step S54 is the same as the processing in step S13 and step S14 of FIG. 3, and will be omitted from description.

Here, in a case where it is determined that the inference task has been selected (YES in step S54), in step S55, the model identification part 107B identifies at least one inference model of which the matching degree calculated by the matching degree calculation part 113 is equal to or greater than a threshold among the plurality of inference models corresponding to the inference task selected by the task selection part 103.

On the other hand, in a case where it is determined that the inference task has not been selected (NO in step S54), in step S56, the model identification part 107B identifies at least one inference model of which the matching degree calculated by the matching degree calculation part 113 is equal to or greater than the threshold among all the inference models.

Next, in step S57, the presentation screen creation part 108B creates a presentation screen for presenting the at least one inference model identified by the identification part 101B to the user.

Processing in step S58 is the same as the processing in step S20 illustrated in FIG. 3, and thus will be omitted from description.

Note that, in the third embodiment, the model identification part 107B identifies, from among the plurality of inference models, at least one inference model whose matching degree calculated by the matching degree calculation part 113 is equal to or greater than the threshold, but the present disclosure is not particularly limited thereto. The model identification part 107B may identify, from among the plurality of inference models, a predetermined number of inference models in order from the inference model having the highest matching degree calculated by the matching degree calculation part 113.

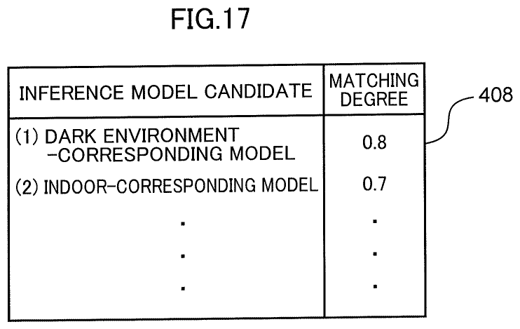

FIG. 17 is a diagram illustrating an example of a presentation screen 408 displayed on the display part 109 in the present third embodiment.

The presentation screen creation part 108B creates a presentation screen 408 for displaying a list of the names of at least one inference model identified by the identification part 101B together with the matching degree.

On the presentation screen 408 illustrated in FIG. 17, the candidates of the inference model suitable for the inference target data set are displayed. The presentation screen 408 displays the names of the inference models in descending order of the matching degree calculated by the matching degree calculation part 113. The presentation screen 408 illustrated in FIG. 17 indicates that the “dark environment-corresponding model” with the matching degree of 0.8 is optimal for the inference target data set, and the “indoor-corresponding model” with the matching degree of 0.7 is second most suitable for the inference target data set.

In this manner, since the names of at least one inference model suitable for the inference target data set are displayed in a list, it is possible to efficiently narrow down the candidates of the machine-learned inference models suitable for the inference target data set without actually inputting the inference target data set to the inference model. In addition, since the matching degree of at least one inference model to the inference target data set is displayed, the user can easily select the optimal inference model by confirming the displayed matching degree.

Note that the presentation screen in the third embodiment may be substantially the same as the presentation screens illustrated in FIGS. 5 to 9 in the first embodiment. In the first embodiment, the names of the inference models are displayed in ascending order of the distance calculated by the distance calculation part 106, whereas in the third embodiment, the names of the inference models are displayed in descending order of the matching degree calculated by the matching degree calculation part 113.

### Fourth Embodiment

In the first embodiment, at least one piece of inference target data is acquired, and at least one inference model corresponding to at least one piece of inference target data is identified from among a plurality of inference models. On the other hand, in the fourth embodiment, at least one keyword is acquired, and at least one inference model corresponding to at least one keyword is identified from among a plurality of inference models.

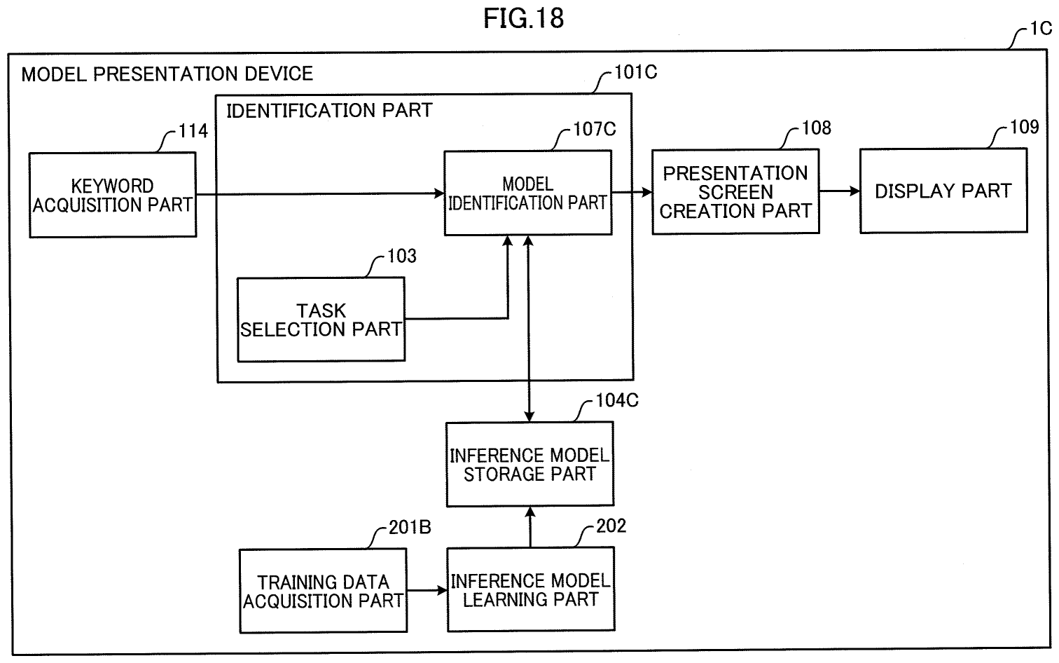

FIG. 18 is a diagram illustrating a configuration of a model presentation device 1C according to the fourth embodiment of the present disclosure.

The model presentation device 1C illustrated in FIG. 18 includes a keyword acquisition part 114, an identification part 101C, an inference model storage part 104C, a presentation screen creation part 108, a display part 109, a training data acquisition part 201B, and an inference model learning part 202.

The keyword acquisition part 114, the identification part 101C, the presentation screen creation part 108, the training data acquisition part 201B, and the inference model learning part 202 are realized by a processor. The inference model storage part 104C is realized by a memory.

In the fourth embodiment, the same components as those in the first to third embodiments will be denoted by the same reference signs as those in the first to third embodiments, and description thereof will be omitted.

The keyword acquisition part 114 acquires at least one keyword. The keyword is, for example, a word related to a use scene that the user wants to infer. For example, the keyword is a word such as “dark environment”, “room”, “factory”, “person”, and “recognition”, and is a word representing the type, place, environment, and detection target of the inference task. Furthermore, the part of speech of the keyword may be any of a noun, an adjective, and a verb.

The keyword acquisition part 114 may acquire at least one keyword input with characters by an input part (not illustrated), or may acquire at least one keyword from a terminal via a network. The input part is, for example, a keyboard, a mouse, and a touch panel. The terminal is a smartphone, a tablet computer, a personal computer, or the like.

Note that the input part may receive not only character input by a keyboard or the like but also voice input by a microphone or the like. In the case that the keyword is input by the voice, the model presentation device 1C may further include a voice recognition part that converts the voice data acquired from the microphone into the character data using the voice recognition technique, and extracts the keyword from the converted character data.

Furthermore, the input part may receive not only an input of a word but also an input of a sentence. In this case, the keyword acquisition part 114 may extract at least one keyword from the input sentence. For example, in a case where a sentence “I want to detect a person in a dark factory.” is input by the user, the keyword acquisition part 114 may extract keywords such as “dark”, “factory”, “person”, and “detect” from the sentence.

The inference model storage part 104C stores in advance a plurality of inference tasks and a plurality of machine-learned inference models in association with each other. Each of the plurality of inference models has a name. Note that the name of the inference model may be input by the user. For example, the input part may receive an input of the name of the inference model by the user.

The identification part 101C identifies at least one inference model corresponding to at least one keyword from among a plurality of inference models that output an inference result using the inference target data as an input.

The identification part 101C includes a task selection part 103 and a model identification part 107C.

The model identification part 107C identifies at least one inference model including at least one keyword acquired by the keyword acquisition part 114 in the name from among the plurality of inference models.

Note that the model identification part 107C may identify at least one inference model including all of at least one keyword in the name from among a plurality of inference models. Furthermore, the model identification part 107C may identify at least one inference model including one of at least one keyword in the name from among a plurality of inference models.

The presentation screen creation part 108 creates a presentation screen for presenting the at least one inference model identified by the identification part 101C to the user. The presentation screen creation part 108 creates a presentation screen for displaying a list of names of at least one inference model identified by the identification part 101C.

Note that, in a case where a plurality of keywords are acquired, the presentation screen creation part 108 may create a presentation screen for displaying a list of the names of the identified at least one inference model in descending order of the number of keywords included in the name. For example, in a case where three keywords are acquired, the presentation screen may display the name of the inference model including three keywords in the name first, display the name of the inference model including two keywords in the name second, and display the name of the inference model including one keyword in the name third.

In addition, the machine learning processing in the model presentation device 1C according to the present fourth embodiment is the same as the processing in step S41, step S42, step S43, and step S46 of the machine learning processing of the third embodiment illustrated in FIG. 15, and thus description thereof is omitted.

Next, model presentation processing in the model presentation device 1C according to the fourth embodiment of the present disclosure will be described.

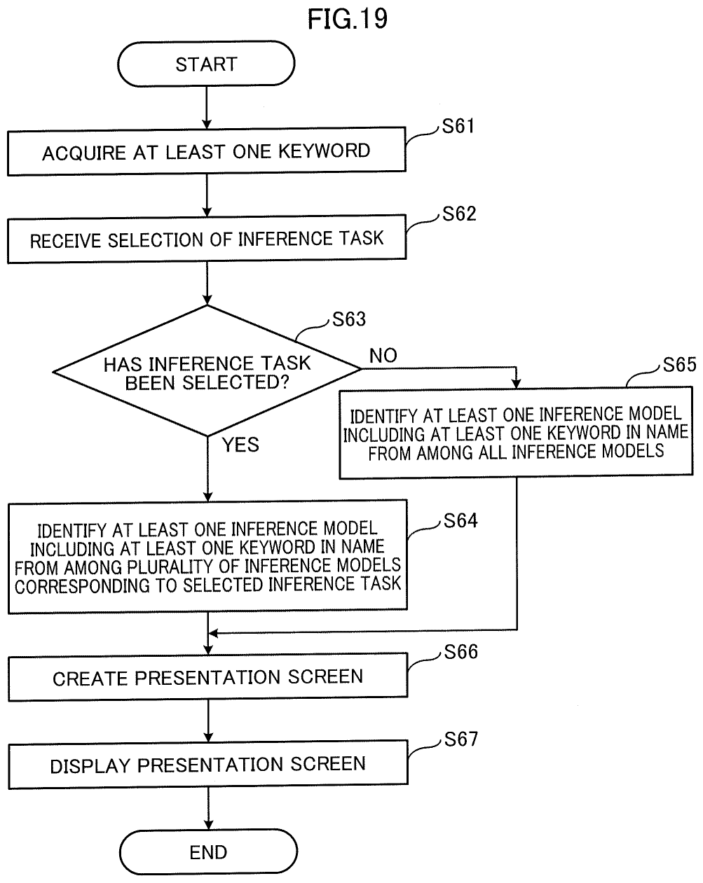

FIG. 19 is a flowchart for explaining model presentation processing in the model presentation device 1C according to the fourth embodiment of the present disclosure.

First, in step S61, the keyword acquisition part 114 acquires at least one keyword.

Processing in step S62 and step S63 is the same as the processing in step S13 and step S14 of FIG. 3, and will be omitted from description.

Here, in a case where it is determined that the inference task has been selected (YES in step S63), in step S64, the model identification part 107C identifies at least one inference model including at least one keyword acquired by the keyword acquisition part 114 in the name from among the plurality of inference models corresponding to the inference task selected by the task selection part 103.

On the other hand, in a case where it is determined that the inference task has not been selected (NO in step S63), in step S65, the model identification part 107C identifies at least one inference model including at least one keyword acquired by the keyword acquisition part 114 in the name from among all the inference models.

Next, in step S66, the presentation screen creation part 108 creates a presentation screen for presenting the at least one inference model identified by the model identification part 107C to the user.

Processing in step S67 is the same as the processing in step S20 illustrated in FIG. 3, and thus will be omitted from description.

In this manner, at least one keyword is acquired, at least one inference model corresponding to the acquired at least one keyword is identified from among a plurality of inference models that output an inference result using the inference target data as an input, and the identified at least one inference model is presented to the user.

Therefore, it is possible to present a candidate of an inference model suitable for the use scene to the user based on the acquired at least one keyword, and it is possible to reduce the cost and time required from selection to introduction of an inference model for inferring the inference target data.

Note that the presentation screen in the fourth embodiment may be substantially the same as the presentation screens illustrated in FIGS. 5 to 9 in the first embodiment. In the first embodiment, the names of the inference models are displayed in ascending order of the distance calculated by the distance calculation part 106, whereas in the fourth embodiment, the name of the inference model including at least one keyword acquired by the keyword acquisition part 114 in the name is displayed.

Furthermore, in the fourth embodiment, a word related to the inference model may be associated with each of the plurality of inference models as a tag. In this case, the inference model storage part 104C stores in advance a plurality of inference tasks, a plurality of machine-learned inference models, and a plurality of pieces of tag information including at least one word related to the inference model in association with each other. The at least one word is, for example, a word related to a use scene that the user wants to infer. For example, at least one word is a word such as “dark environment”, “room”, “factory”, “person”, and “recognition”, and is a word representing the type, place, environment, and detection target of the inference task. Furthermore, the part of speech of at least one word may be any of a noun, an adjective, and a verb. Note that the tag information may be input by the user. For example, the input part may receive an input of the tag information by the user.

Then, the model identification part 107C may identify at least one inference model associated with a tag including at least one keyword acquired by the keyword acquisition part 114 from among the plurality of inference models. In a case where it is determined that the inference task has been selected, the model identification part 107C may identify at least one inference model associated with a tag including at least one keyword acquired by the keyword acquisition part 114 from among a plurality of inference models corresponding to the inference task selected by the task selection part 103. On the other hand, in a case where it is determined that the inference task has not been selected, the model identification part 107C may identify at least one inference model associated with a tag including at least one keyword acquired by the keyword acquisition part 114 from among all the inference models.

### Fifth Embodiment

In the fourth embodiment, at least one keyword is acquired, and at least one inference model including at least one keyword in a name is identified from among a plurality of inference models. On the other hand, in the fifth embodiment, a distance between a first word vector obtained by vectorizing at least one keyword and each of a plurality of second word vectors obtained by vectorizing at least one word included in a name of each of a plurality of inference models or at least one word related to an inference model associated as a tag with each of a plurality of inference models is calculated, and at least one inference model having a calculated distance equal to or less than a threshold is identified from among the plurality of inference models.

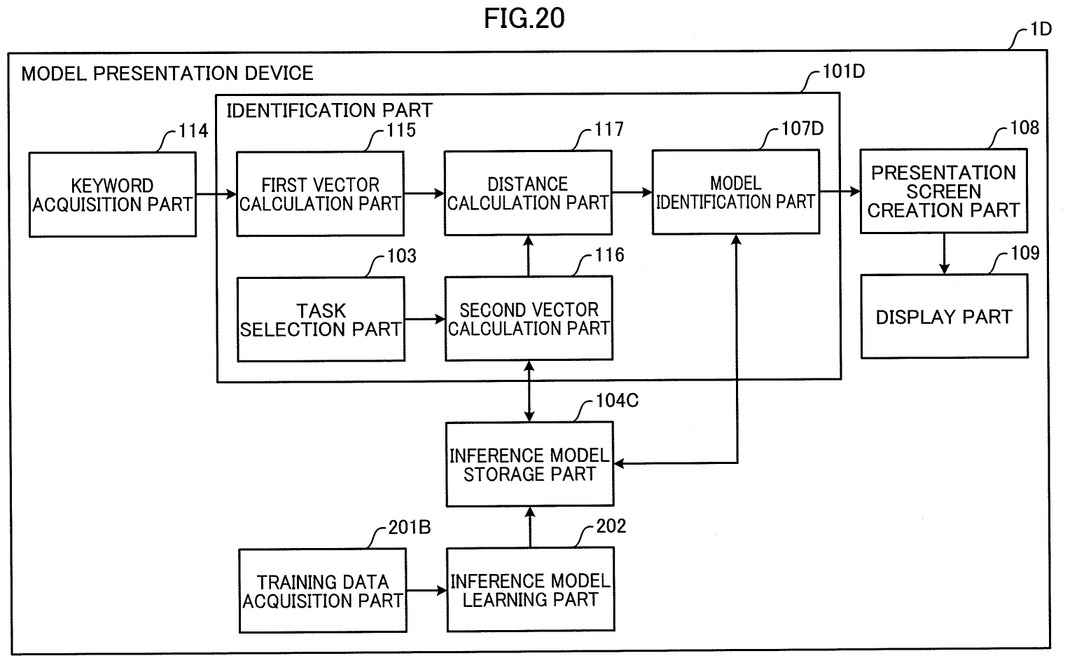

FIG. 20 is a diagram illustrating a configuration of a model presentation device 1D according to the fifth embodiment of the present disclosure.

The model presentation device 1D illustrated in FIG. 20 includes a keyword acquisition part 114, an identification part 101D, an inference model storage part 104C, a presentation screen creation part 108, a display part 109, a training data acquisition part 201B, and an inference model learning part 202.

The keyword acquisition part 114, the identification part 101D, the presentation screen creation part 108, the training data acquisition part 201B, and the inference model learning part 202 are realized by a processor. The inference model storage part 104C is realized by a memory.

In the fifth embodiment, the same components as those in the first to fourth embodiments are denoted by the same reference numerals, and description thereof will be omitted.

The identification part 101D includes a task selection part 103, a model identification part 107D, a first vector calculation part 115, a second vector calculation part 116, and a distance calculation part 117.

The first vector calculation part 115 calculates a first word vector obtained by vectorizing at least one keyword acquired by the keyword acquisition part 114. Note that, as a technique for vectorizing a word, there is, for example, “Word2vec”.

In a case where a plurality of word vectors are calculated from a plurality of keywords, the first vector calculation part 115 may calculate an average of the plurality of word vectors as the first word vector. Furthermore, the first vector calculation part 115 may calculate one first word vector from a plurality of keywords.

The second vector calculation part 116 calculates a plurality of second word vectors obtained by vectorizing at least one word included in the name of each of the plurality of inference models. Note that, in a case where at least one word related to the inference model is associated with each of the plurality of inference models as a tag, the second vector calculation part 116 calculates a plurality of second word vectors obtained by vectorizing at least one word associated with each of the plurality of inference models as a tag. Furthermore, the second vector calculation part 116 may calculate a plurality of second word vectors obtained by vectorizing at least one word included in both the name and the tag of each of the plurality of inference models.

Furthermore, in a case where a plurality of words are included in the name or tag of the inference model and a plurality of word vectors are calculated for one inference model, the second vector calculation part 116 may calculate an average of the plurality of word vectors as the second word vector of one inference model. Furthermore, the second vector calculation part 116 may calculate one second word vector from a plurality of words included in the name or tag of one inference model.

The distance calculation part 117 calculates a distance between the first word vector calculated by the first vector calculation part 115 and each of the plurality of second word vectors calculated by the second vector calculation part 116.

The model identification part 107D identifies at least one inference model in which the distance calculated by the distance calculation part 117 is equal to or less than a threshold from among the plurality of inference models.

The presentation screen creation part 108 creates a presentation screen for presenting the at least one inference model identified by the identification part 101D to the user. The presentation screen creation part 108 creates a presentation screen for displaying a list of names of at least one inference model identified by the identification part 101D. Note that the presentation screen creation part 108 may create a presentation screen for displaying a list of the names of the identified at least one inference model in ascending order of the calculated distances.

Note that the machine learning processing in the model presentation device 1D according to the present fifth embodiment is the same as the processing in step S41, step S42, step S43, and step S46 of the machine learning processing of the third embodiment illustrated in FIG. 15, and thus description thereof is omitted.

Next, model presentation processing in the model presentation device 1D according to the fifth embodiment of the present disclosure will be described.

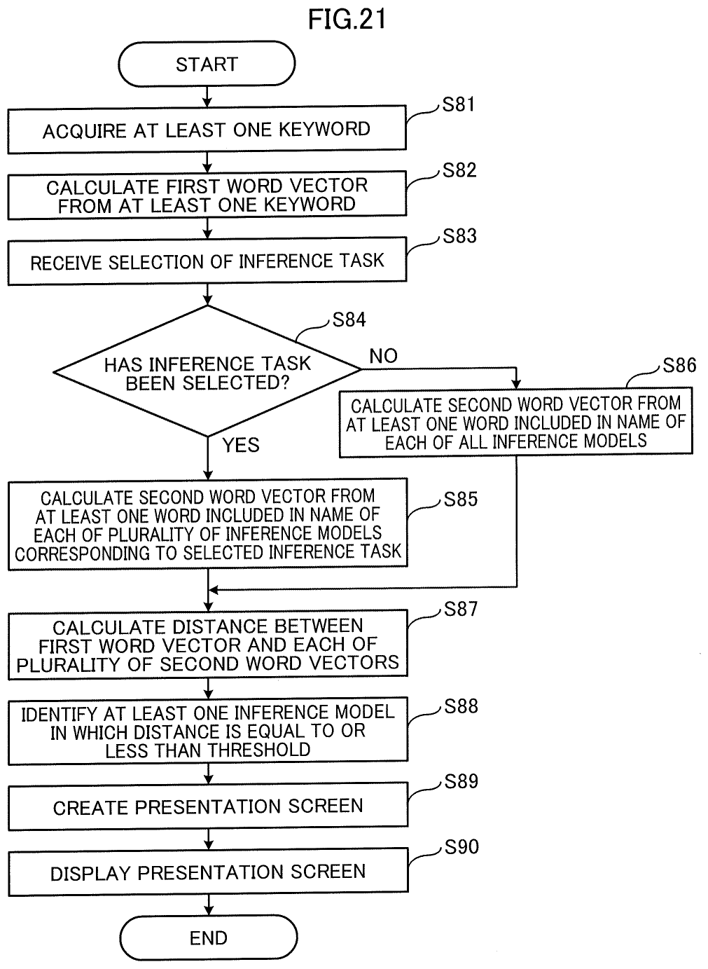

FIG. 21 is a flowchart for explaining model presentation processing in the model presentation device 1D according to the fifth embodiment of the present disclosure.

First, in step S81, the keyword acquisition part 114 acquires at least one keyword.

Next, in step S82, the first vector calculation part 115 calculates the first word vector from at least one keyword acquired by the keyword acquisition part 114.

Processing in step S83 and step S84 is the same as the processing in step S13 and step S14 of FIG. 3, and will be omitted from description.

Here, in a case where it is determined that the inference task has been selected (YES in step S84), in step S85, the second vector calculation part 116 calculates the second word vector from at least one word included in the name of each of the plurality of inference models corresponding to the inference task selected by the task selection part 103.

On the other hand, in a case where it is determined that the inference task has not been selected (NO in step S84), in step S86, the second vector calculation part 116 calculates the second word vector from at least one word included in the name of each of all the inference models.

Next, in step S87, the distance calculation part 117 calculates a distance between the first word vector calculated by the first vector calculation part 115 and each of the plurality of second word vectors calculated by the second vector calculation part 116.

Next, in step S88, the model identification part 107D identifies at least one inference model in which the distance calculated by the distance calculation part 117 is equal to or less than a threshold from among the plurality of inference models or all the inference models corresponding to the selected inference task.

Next, in step S89, the presentation screen creation part 108 creates a presentation screen for presenting the at least one inference model identified by the model identification part 107D to the user.

Processing in step S90 is the same as the processing in step S20 illustrated in FIG. 3, and thus will be omitted from description.

Note that, in the fifth embodiment, the model identification part 107D identifies, from among a plurality of inference models, at least one inference model whose distance calculated by the distance calculation part 117 is equal to or less than the threshold, but the present disclosure is not particularly limited thereto. The model identification part 107D may identify, from among the plurality of inference models, a predetermined number of inference models in order from among the inference model having the shortest distance calculated by the distance calculation part 117.

In addition, the presentation screen in the fifth embodiment may be substantially the same as the presentation screens illustrated in FIGS. 5 to 9 in the first embodiment. In the first embodiment, the names of the inference models are displayed in ascending order of the distance calculated by the distance calculation part 106, whereas in the fifth embodiment, the names of the inference models are displayed in ascending order of the distance calculated by the distance calculation part 117.

### Sixth Embodiment

In the fourth embodiment, at least one keyword is acquired, and at least one inference model including at least one keyword in a name is identified from among a plurality of inference models. On the other hand, in the sixth embodiment, the matching degree of each of the plurality of inference models with respect to the acquired at least one keyword is calculated, and at least one inference model whose calculated matching degree is equal to or greater than a threshold is identified from among the plurality of inference models.

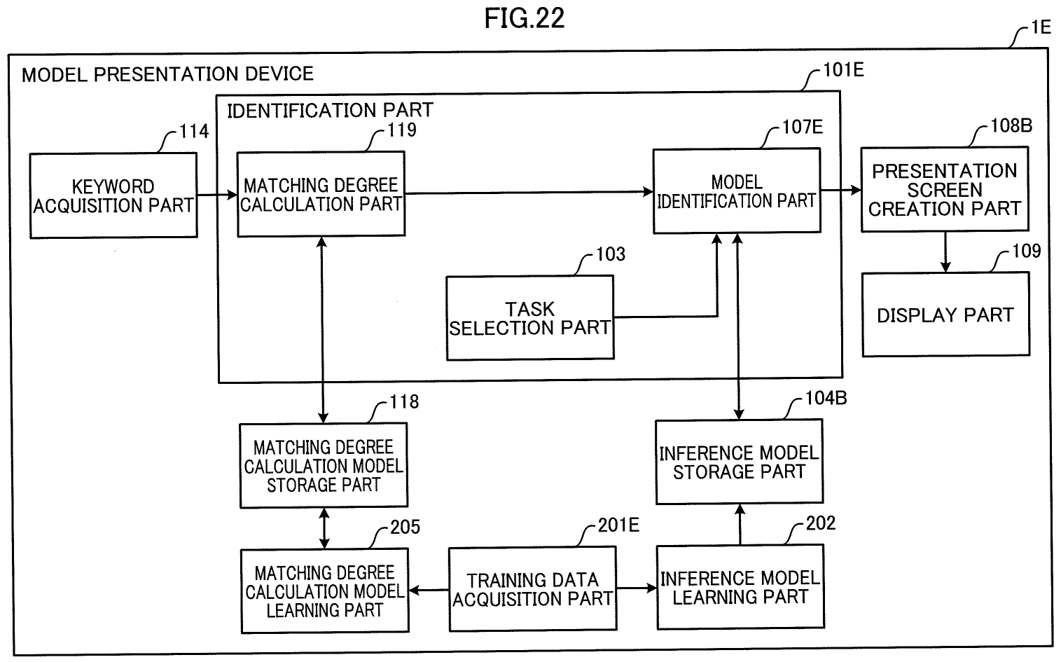

FIG. 22 is a diagram illustrating a configuration of a model presentation device 1E according to the sixth embodiment of the present disclosure.

The model presentation device 1E illustrated in FIG. 22 includes a keyword acquisition part 114, an identification part 101E, an inference model storage part 104B, a presentation screen creation part 108B, a display part 109, a matching degree calculation model storage part 118, a training data acquisition part 201E, an inference model learning part 202, and a matching degree calculation model learning part 205.

The keyword acquisition part 114, the identification part 101E, the presentation screen creation part 108B, the training data acquisition part 201E, the inference model learning part 202, and the matching degree calculation model learning part 205 are realized by a processor. The inference model storage part 104B and the matching degree calculation model storage part 118 are realized by memories.

The identification part 101E includes a task selection part 103, a model identification part 107E, and a matching degree calculation part 119.

In the sixth embodiment, the same components as those in the first to fifth embodiments are denoted by the same reference numerals, and description thereof will be omitted.

The matching degree calculation model storage part 118 stores in advance a matching degree calculation model that outputs the matching degree of each of a plurality of inference models using at least one keyword as an input.

The matching degree calculation part 119 calculates the matching degree of each of the plurality of inference models for at least one keyword acquired by the keyword acquisition part 114. The matching degree calculation part 119 inputs at least one keyword acquired by the keyword acquisition part 114 to the matching degree calculation model, and acquires the matching degree of each of the plurality of inference models with respect to the at least one keyword from the matching degree calculation model.

The model identification part 107E identifies, from among the plurality of inference models, at least one inference model whose matching degree calculated by the matching degree calculation part 119 is equal to or greater than a threshold.

The presentation screen creation part 108B creates a presentation screen for displaying a list of the names of at least one inference model identified by the model identification part 107E together with the matching degree. At this time, the names of the at least one inference model identified by the model identification part 107E may be displayed in a list in descending order of the calculated matching degree.

The training data acquisition part 201E acquires a training data set corresponding to an inference model for performing machine learning. The training data acquisition part 201E outputs the acquired training data set to the inference model learning part 202. Furthermore, the training data acquisition part 201E acquires at least one word included in the name or tag of the inference model to be learned using the acquired training data set. The training data acquisition part 201E outputs at least one word included in the name or tag of the inference model to be learned using the acquired training data set and information for identifying the inference model to be learned using the training data set to the matching degree calculation model learning part 205. Note that the training data acquisition part 201E may acquire at least one word included in both the name and the tag of the inference model to be learned using the acquired training data set.

Note that the training data acquisition part 201E may acquire history information obtained in the past in the fourth embodiment. In this case, the training data acquisition part 201E may acquire at least one keyword acquired by the keyword acquisition part 114 of the fourth embodiment and the name of the inference model finally identified by the model identification part 107C of the fourth embodiment.

Furthermore, the training data acquisition part 201E may acquire a history obtained in the past in the fifth embodiment. In this case, the training data acquisition part 201E may acquire at least one keyword acquired by the keyword acquisition part 114 of the fifth embodiment, the distance calculated by the distance calculation part 117 of the fifth embodiment, and the name of the inference model finally identified by the model identification part 107D of the fifth embodiment.

The matching degree calculation model learning part 205 performs machine learning of the matching degree calculation model using at least one word acquired by the training data acquisition part 201E. The matching degree calculation model is a machine learning model using a neural network such as deep learning, but may be another machine learning model. For example, the matching degree calculation model may be a machine learning model using random forest, genetic programming, or the like.

The machine learning in the matching degree calculation model learning part 205 is implemented by, for example, a back propagation (BP) method in deep learning or the like. Specifically, the matching degree calculation model learning part 205 inputs at least one word to the matching degree calculation model, and acquires the matching degree of each of the plurality of inference models output by the matching degree calculation model. Then, the matching degree calculation model learning part 205 adjusts the matching degree calculation model such that the matching degree for each of the plurality of inference models becomes the correct answer information. Here, the correct answer information is information in which, among the matching degrees of the plurality of inference models, the matching degree of an inference model using at least one word that has been input for learning is set to 1.0, and the matching degree of another inference model is set to 0.0. The matching degree calculation model learning part 205 improves the matching degree calculation accuracy of the matching degree calculation model by repeating adjustment of the matching degree calculation model for a plurality of sets (for example, thousands of sets) of at least one word and correct answer information different from each other.

In the sixth embodiment, the model presentation device 1E includes the training data acquisition part 201E, the inference model learning part 202, and the matching degree calculation model learning part 205, but the present disclosure is not particularly limited thereto. The model presentation device 1E may not include the training data acquisition part 201E, the inference model learning part 202, and the matching degree calculation model learning part 205, and an external computer connected to the model presentation device 1E via a network may include the training data acquisition part 201E, the inference model learning part 202, and the matching degree calculation model learning part 205. In this case, the model presentation device 1E may further include a communication part that receives a plurality of machine-learned inference models and matching degree calculation models from the external computer, stores the plurality of received inference models in the inference model storage part 104B, and stores the received matching degree calculation models in the matching degree calculation model storage part 118.

In addition, the matching degree calculation model learning part 205 may learn the matching degree calculation model by using the history information obtained in the past in the fourth embodiment acquired by the training data acquisition part 201E.

In addition, the matching degree calculation model learning part 205 may learn the matching degree calculation model by using the history information obtained in the past in the fifth embodiment acquired by the training data acquisition part 201E. In this case, the matching degree calculation model learning part 205 may normalize the distance calculated by the distance calculation part 117 of the fifth embodiment, and use the normalized distance for machine learning as correct answer information of the matching degrees of a plurality of inference models.

Next, machine learning processing in the model presentation device 1E according to the sixth embodiment of the present disclosure will be described.

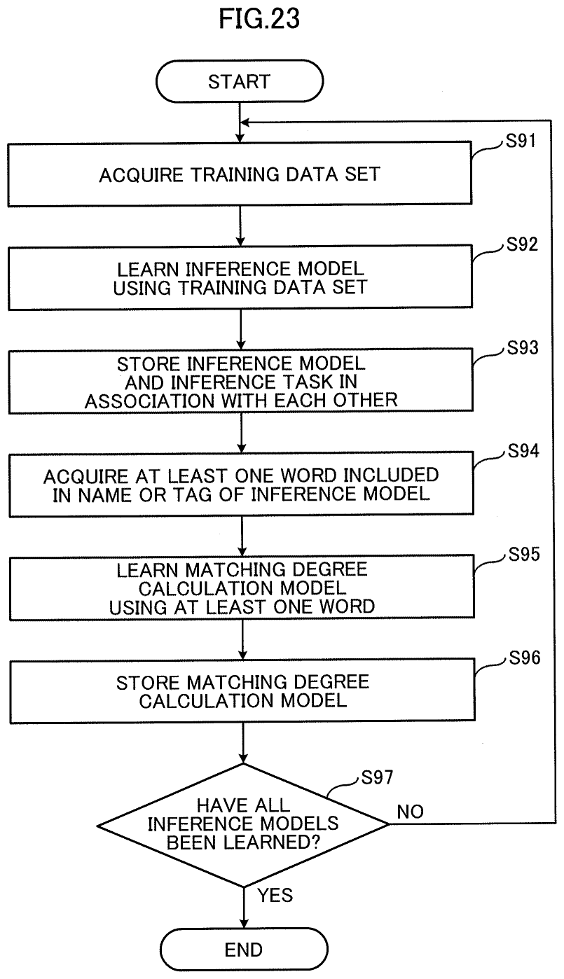

FIG. 23 is a flowchart for explaining machine learning processing in the model presentation device 1E according to the sixth embodiment of the present disclosure.

Processing in steps S91 to S93 is the same as the processing in steps S41 to S43 in FIG. 15, and thus will be omitted from description.

Next, in step S94, the training data acquisition part 201E acquires at least one word included in the name or tag of the inference model to be learned using the training data set acquired by the training data acquisition part 201E.

Next, in step S95, the matching degree calculation model learning part 205 learns the matching degree calculation model by using at least one word acquired by the training data acquisition part 201E.

Next, in step S96, the matching degree calculation model learning part 205 stores the learned matching degree calculation model in the matching degree calculation model storage part 118.

Processing in step S97 is the same as the processing in step S46 illustrated in FIG. 15, and thus will be omitted from description.

Note that the processing of steps S91 to S97 is repeated until learning of all the inference models is completed, but in the processing of step S95 of the second and subsequent times, the matching degree calculation model learning part 205 reads the matching degree calculation model stored in the matching degree calculation model storage part 118 and learns the read matching degree calculation model. Then, in the processing of step S96, the matching degree calculation model learning part 205 stores the learned matching degree calculation model again in the matching degree calculation model storage part 118. As a result, the matching degree calculation model stored in the matching degree calculation model storage part 118 is updated, and learning of the matching degree calculation model proceeds.

Next, model presentation processing in the model presentation device 1E according to the sixth embodiment of the present disclosure will be described.

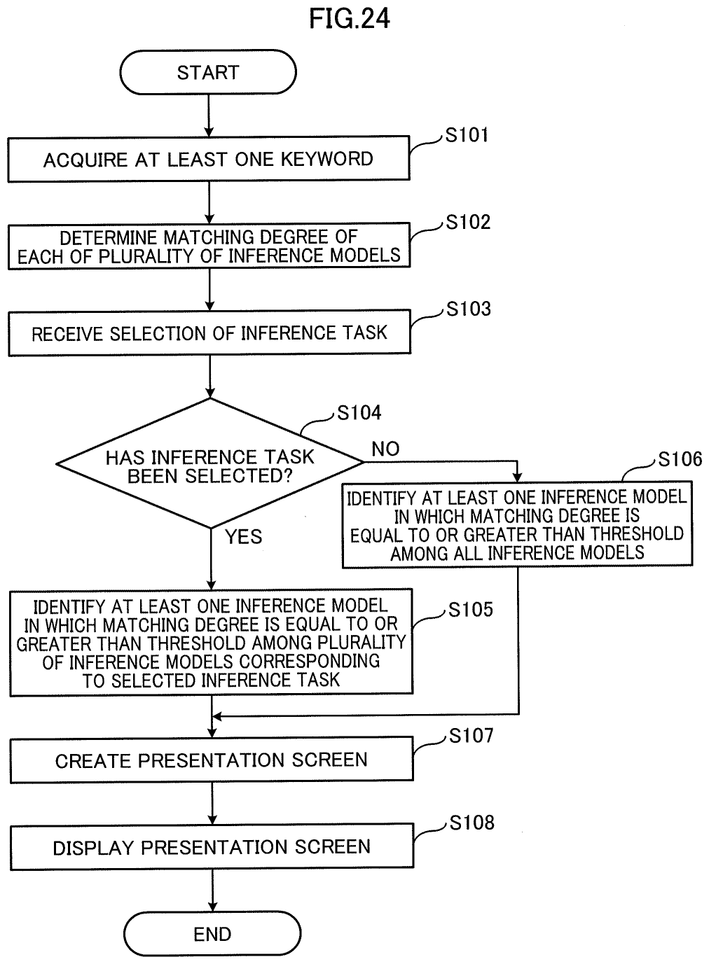

FIG. 24 is a flowchart for explaining model presentation processing in the model presentation device 1E according to the sixth embodiment of the present disclosure.

First, in step S101, the keyword acquisition part 114 acquires at least one keyword.

Next, in step S102, the matching degree calculation part 119 calculates the matching degree of each of the plurality of inference models for at least one keyword acquired by the keyword acquisition part 114. The matching degree calculation part 119 inputs at least one keyword acquired by the keyword acquisition part 114 to the matching degree calculation model, and acquires the matching degree of each of the plurality of inference models with respect to the at least one keyword from the matching degree calculation model.

Processing in step S103 and step S104 is the same as the processing in step S13 and step S14 of FIG. 3, and will be omitted from description.

Here, in a case where it is determined that the inference task has been selected (YES in step S104), in step S105, the model identification part 107E identifies at least one inference model of which the matching degree calculated by the matching degree calculation part 119 is equal to or greater than a threshold among the plurality of inference models corresponding to the inference task selected by the task selection part 103.

On the other hand, in a case where it is determined that the inference task has not been selected (NO in step S104), in step S106, the model identification part 107E identifies at least one inference model of which the matching degree calculated by the matching degree calculation part 119 is equal to or greater than the threshold among all the inference models.

Next, in step S107, the presentation screen creation part 108B creates a presentation screen for presenting the at least one inference model identified by the identification part 101E to the user.

Processing in step S108 is the same as the processing in step S20 illustrated in FIG. 3, and thus will be omitted from description.

Note that, in the sixth embodiment, the model identification part 107E identifies, from among the plurality of inference models, at least one inference model whose matching degree calculated by the matching degree calculation part 119 is equal to or greater than the threshold, but the present disclosure is not particularly limited thereto. The model identification part 107E may identify, from among the plurality of inference models, a predetermined number of inference models in order from the inference model having the highest matching degree calculated by the matching degree calculation part 119.

The presentation screen in the sixth embodiment may be identical to presentation screen 408 in FIG. 17 in the third embodiment. In addition, the presentation screen in the sixth embodiment may be substantially the same as the presentation screens illustrated in FIGS. 5 to 9 in the first embodiment. In the first embodiment, the names of the inference models are displayed in ascending order of the distance calculated by the distance calculation part 106, whereas in the sixth embodiment, the names of the inference models are displayed in descending order of the matching degree calculated by the matching degree calculation part 119.

Note that the first to third embodiments in which at least one inference model is identified using at least one piece of inference target data and the fourth to sixth embodiments in which at least one inference model is identified using at least one keyword may be combined.

In this case, the model presentation device may include an integration part that calculates a logical product or a logical sum of at least one inference model identified according to at least one piece of inference target data by the identification parts 101, 101A, and 101B and at least one inference model identified according to at least one keyword by the identification parts 101C, 101D, and 101E. Furthermore, the matching degree calculation part may calculate the matching degree of each of the plurality of inference models for at least one piece of inference target data and at least one keyword. The matching degree calculation part may input at least one piece of inference target data and at least one keyword to the matching degree calculation model, and acquire the matching degree of each of the plurality of inference models with respect to at least one piece of inference target data and at least one keyword from the matching degree calculation model.

In addition, the model identification part may calculate a sum or an average of the matching degree of each of the plurality of inference models acquired by inputting at least one piece of inference target data to the matching degree calculation model and the matching degree of each of the plurality of inference models acquired by inputting at least one keyword to the matching degree calculation model. Then, the model identification part may identify at least one inference model from among the plurality of inference models in descending order of the sum or average of the calculated matching degree. In addition, since the matching degree calculated from at least one piece of inference target data has higher accuracy than the matching degree calculated from at least one keyword, the model identification part may weight the matching degree calculated from at least one piece of inference target data.

In addition, the presentation screen may display all of at least one inference model identified according to at least one piece of inference target data by the identification parts 101, 101A, and 101B and at least one inference model identified according to at least one keyword by the identification parts 101C, 101D, and 101E. In addition, the presentation screen may display overlapping inference models of at least one inference model identified according to at least one piece of inference target data by the identification parts 101, 101A, and 101B and at least one inference model identified according to at least one keyword by the identification parts 101C, 101D, and 101E.

Note that, in each of the above embodiments, each constituent element may be implemented by including dedicated hardware or by executing a software program suitable for each constituent element. Each constituent element may be implemented by a program execution part, such as a CPU or a processor, reading and executing a software program recorded in a recording medium such as a hard disk or a semiconductor memory. Further, a program may be recorded onto a recording medium and transferred or transferred via a network, so that the program is performed by another independent computer system.

Some or all functions of the device according to the embodiment of the present disclosure are implemented as large scale integration (LSI), which is typically an integrated circuit. These may be individually integrated into one chip, or may be integrated into one chip so as to include some or all of these. Further, circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Some or all functions of the device according to the embodiments of the present disclosure may be implemented by a processor such as a CPU executing a program.

Further, all numbers used above are illustrated to specifically describe the present disclosure, and the present disclosure is not limited to the illustrated numbers.

Further, order in which steps illustrated in the above flowchart are executed is for specifically describing the present disclosure, and may be any order other than the above order as long as a similar effect is obtained. Further, some of the above steps may be executed simultaneously (in parallel) with other steps.

The technique according to the present disclosure can present a user with a candidate of an inference model suitable for a use scene, and can reduce the cost and time required from selection to introduction of an inference model for inferring inference target data, and thus is useful as a technique for identifying an inference model optimal for the inference target data from among a plurality of inference models.

1. An information processing method by a computer, the method comprising:
acquiring at least one piece of inference target data;
identifying at least one inference model according to the at least one piece of inference target data from among a plurality of inference models that output an inference result using the inference target data as an input;
creating a presentation screen for presenting the identified at least one inference model to a user; and
outputting the created presentation screen.

2. An information processing method by a computer, the method comprising:
obtaining at least one keyword;
identifying at least one inference model corresponding to the at least one keyword from among a plurality of inference models that output an inference result using inference target data as an input;
creating a presentation screen for presenting the identified at least one inference model to a user; and
outputting the created presentation screen.

3. The information processing method according to claim 1, wherein
in the identifying of the at least one inference model, a first representative feature vector of the acquired at least one piece of inference target data is extracted, a distance between the extracted first representative feature vector and a second representative feature vector of each of a plurality of training data sets used for machine learning of each of the plurality of inference models is calculated, and the at least one inference model in which the calculated distance is equal to or less than a threshold is identified from among the plurality of inference models.

4. The information processing method according to claim 1, wherein
in the acquiring of the at least one piece of inference target data, an inference target data set including a plurality of pieces of inference target data is acquired, and
in the identifying of the at least one inference model, an inter-distribution distance between the acquired inference target data set and each of a plurality of training data sets used when machine learning is performed on each of the plurality of inference models is calculated, and the at least one inference model in which the calculated inter-distribution distance is equal to or less than a threshold is identified from among the plurality of inference models.

5. The information processing method according to claim 1, wherein
in the identifying of the at least one inference model, a matching degree of each of the plurality of inference models with respect to the acquired at least one piece of inference target data is calculated, and the at least one inference model of which the calculated matching degree is equal to or greater than a threshold is identified from among the plurality of inference models.

6. The information processing method according to claim 2, wherein
each of the plurality of inference models is assigned with a name, and
in the identifying of the at least one inference model, the at least one inference model including the acquired at least one keyword in the name is identified from among the plurality of inference models.

7. The information processing method according to claim 2, wherein
a word related to an inference model is associated with each of the plurality of inference models as a tag, and
in the identifying of the at least one inference model, the at least one inference model associated with the tag including the acquired at least one keyword is identified from among the plurality of inference models.

8. The information processing method according to claim 2, wherein in the identifying of the at least one inference model, a first word vector obtained by vectorizing the acquired at least one keyword is calculated, a plurality of second word vectors obtained by vectorizing at least one word included in a name of each of the plurality of inference models or at least one word related to an inference model associated with each of the plurality of inference models as a tag is calculated, a distance between the calculated first word vector and each of the plurality of calculated second word vectors is calculated, and the at least one inference model in which the calculated distance is equal to or less than a threshold is identified from among the plurality of inference models.

9. The information processing method according to claim 2, wherein in the identifying of the at least one inference model, a matching degree of each of the plurality of inference models with respect to the acquired at least one keyword is calculated, and the at least one inference model of which the calculated matching degree is equal to or greater than a threshold is identified from among the plurality of inference models.

10. The information processing method according to claim 1, wherein in the creating of the presentation screen, the presentation screen for displaying a list of names of the identified at least one inference model is created.

11. The information processing method according to claim 5, wherein in the creating of the presentation screen, the presentation screen for displaying a list of names of the identified at least one inference model together with the matching degree is created.

12. The information processing method according to claim 1, wherein in the creating of the presentation screen, the presentation screen for displaying a list of the identified at least one inference model in a selectable state for each use environment and displaying a list of inference models corresponding to the selected use environment for each use location is created.

13. The information processing method according to claim 1, wherein in the creating of the presentation screen, the presentation screen for displaying a list of names of a plurality of inference tasks that can be inferred by the at least one inference model in a selectable state and displaying a list of names of the at least one inference model corresponding to a selected inference task is created.

14. The information processing method according to claim 1, wherein in the creating of the presentation screen, the presentation screen for displaying a list of names of the identified at least one inference model in a selectable state, displaying a list of names of at least one piece of inference target data in a selectable state, and in a case where any one of the names of the at least one inference model is selected and any one of the names of the at least one piece of inference target data is selected, displaying an inference result obtained by inferring the selected inference target data by the selected inference model is created.

15. The information processing method according to claim 1, wherein in the creating of the presentation screen, a first presentation screen for displaying a list of names of the identified at least one inference model in a selectable state is created, a second presentation screen for displaying a list of names of at least one piece of inference target data in a selectable state is created in a case where any one of the names of the at least one inference model is selected, and in a case where any one of the names of the at least one piece of inference target data is selected, a third presentation screen for displaying an inference result obtained by inferring the inference target data selected on the second presentation screen by the inference model selected on the first presentation screen is created.

16. An information processing device comprising:
an acquisition part that acquires at least one piece of inference target data;
an identification part that identifies at least one inference model according to the at least one piece of inference target data from among a plurality of inference models that output an inference result using the inference target data as an input;
a creation part that creates a presentation screen for presenting the identified at least one inference model to a user; and
an output part that outputs the created presentation screen.

17. A non-transitory computer readable recording medium storing an information processing program for causing a computer to execute:
acquiring at least one piece of inference target data;
identifying at least one inference model according to the at least one piece of inference target data from among a plurality of inference models that output an inference result using the inference target data as an input;
creating a presentation screen for presenting the identified at least one inference model to a user; and
outputting the created presentation screen.

18. An information processing device comprising:
an acquisition part that acquires at least one keyword;
an identification part that identifies at least one inference model according to the at least one keyword from among a plurality of inference models that output an inference result using inference target data as an input;
a creation part that creates a presentation screen for presenting the identified at least one inference model to a user; and
an output part that outputs the created presentation screen.

19. A non-transitory computer readable recording medium storing an information processing program for causing a computer to execute:
acquiring at least one keyword;
identifying at least one inference model according to the at least one keyword from among a plurality of inference models that output an inference result using inference target data as an input;
creating a presentation screen for presenting the identified at least one inference model to a user; and
outputting the created presentation screen.
